(19) United States
(12) Patent Application Publication
(10) Pub. No.: US 2025/0298748 A1
(43) Pub. Date: Sep. 25, 2025

(54) MEMORY SYSTEM

(71) Applicant: Kioxia Corporation, Tokyo (JP)

(72) Inventors: Hirotsugu KAJIHARA, Yokohama (JP); Akiyuki KANEKO, Yokohama (JP); Daisuke TAKI, Yokohama (JP); Kazuhiro HIWADA, Kamakura (JP)

(73) Assignee: Kioxia Corporation, Tokyo (JP)

(21) Appl. No.: 18/829,569

(22) Filed: Sep. 10, 2024

(30) Foreign Application Priority Data
Mar. 21, 2024 (JP) 2024-045408

(51) Int. Cl. G06F 12/0895; G06F 12/0862; G06F 12/0891

(52) U.S. Cl. CPC G06F 12/0895; G06F 12/0862; G06F 12/0891

(57) ABSTRACT

According to one embodiment, a memory system includes a nonvolatile memory, and a memory controller including first and second caches and a first controller. The first cache includes a first memory unit and a first control unit. The second cache includes a second memory unit and a second control unit. The first memory unit includes a plurality of entries each having a cache tag including a first field and a cache line. Upon receiving a first prefetch request for first data of a first logical address, the first control unit stores the first data in the cache line of a first entry included in the first memory unit, and stores a first value in the first field of the first entry. The first control unit maintains the first entry until receiving a read request or a write request for the first logical address from the host.

### CROSS-REFERENCE TO RELATED APPLICATIONS

This application is based upon and claims the benefit of priority from Japanese Patent Application No. 2024-045408, filed Mar. 21, 2024, the entire contents of which are incorporated herein by reference.

### FIELD

Embodiments described herein relate generally to a memory system.

### BACKGROUND

A memory system including a NAND flash memory as a nonvolatile memory and a memory controller that controls the nonvolatile memory is known.

### BRIEF DESCRIPTION OF DRAWINGS

FIG. 1 is a block diagram illustrating an example of a configuration of an information processing system including a memory system according to a first embodiment.

FIG. 2 is a block diagram illustrating an example of a configuration of a nonvolatile memory included in the memory system according to the first embodiment.

FIG. 3 is a block diagram illustrating an example of a hardware configuration of a memory controller included in the memory system according to the first embodiment.

FIG. 4 is a diagram illustrating an example of a configuration of an L2P table used in the memory system according to the first embodiment.

FIG. 5 is a diagram illustrating an example of a configuration of a memory unit of a first cache included in the memory system according to the first embodiment.

FIG. 6 is a diagram illustrating an example of a configuration of a memory unit of a second cache included in the memory system according to the first embodiment.

FIG. 7 is a block diagram illustrating an example of a functional configuration of the memory controller included in the memory system according to the first embodiment.

FIG. 8 is a diagram illustrating an example of a state transition of a cache tag of a target entry of the memory unit of the first cache included in the memory system according to the first embodiment.

FIG. 9 is a block diagram illustrating an example of a functional configuration of a memory controller included in a memory system according to a first modification of the first embodiment.

FIG. 10 is a block diagram illustrating an example of a functional configuration of a memory controller included in a memory system according to a second modification of the first embodiment.

FIG. 11 is a block diagram illustrating an example of a hardware configuration of a memory controller included in a memory system according to a second embodiment.

FIG. 12 is a diagram illustrating an example of a configuration of a memory unit of a first cache included in the memory system according to the second embodiment.

FIG. 13 is a block diagram illustrating an example of a functional configuration of the memory controller included in the memory system according to the second embodiment.

FIG. 14 is a diagram illustrating an example of a state transition of a cache tag of a target entry of the memory unit of the first cache included in the memory system according to the second embodiment.

FIG. 15 is a diagram illustrating an example of a configuration of a memory unit of a first cache included in a memory system according to a third embodiment.

FIG. 16 is a diagram illustrating a relationship between a management size of an L2P table and a size of a cache line of the memory unit of the first cache in the memory system according to the third embodiment.

FIG. 17 is a flowchart illustrating an example of the operation of a first cache included in a memory system according to a fourth embodiment.

FIG. 18 is a flowchart illustrating an example of the operation of a second cache included in the memory system according to the fourth embodiment.

FIG. 19 is a flowchart illustrating an example of the operation of the second cache included in the memory system according to the fourth embodiment.

FIG. 20 is a flowchart illustrating an example of the operation of the second cache included in the memory system according to the fourth embodiment.

FIG. 21 is a flowchart illustrating an example of the operation of the first cache included in the memory system according to the fourth embodiment.

FIG. 22 is a flowchart illustrating an example of the operation of the first cache included in the memory system according to the fourth embodiment.

FIG. 23 is a flowchart illustrating an example of the operation of the first cache included in the memory system according to the fourth embodiment.

FIG. 24 is a flowchart illustrating an example of the operation of the first cache included in the memory system according to the fourth embodiment.

FIG. 25 is a flowchart illustrating an example of the operation of the second cache included in the memory system according to the fourth embodiment.

FIG. 26 is a flowchart illustrating an example of the operation of the first cache included in the memory system according to the fourth embodiment.

FIG. 27 is a flowchart illustrating an example of the operation of the second cache included in the memory system according to the fourth embodiment.

FIG. 28 is a flowchart illustrating an example of the operation of a first cache included in a memory system according to a fifth embodiment.

FIG. 29 is a flowchart illustrating an example of the operation of a first cache included in a memory system according to a sixth embodiment.

FIG. 30 is a flowchart illustrating an example of the operation of a second cache included in the memory system according to the sixth embodiment.

FIG. 31 is a flowchart illustrating an example of the operation of the first cache included in the memory system according to the sixth embodiment.

FIG. 32 is a flowchart illustrating an example of the operation of the second cache included in the memory system according to the sixth embodiment.

### DETAILED DESCRIPTION

In general, according to one embodiment, a memory system includes a nonvolatile memory and a memory controller. The memory controller includes a first cache connectable to a host, a second cache connected to the first cache, and a first controller that controls a nonvolatile memory. The first cache includes a first memory unit that has an SRAM as a memory element and stores prefetch data and read data from the nonvolatile memory, and a first control unit that controls the first memory unit. The second cache includes a second memory unit that has a DRAM as a memory element and stores the read data and write data from the host, and a second control unit that controls the second memory unit. Each of a plurality of logical addresses designated by the host is mapped to the first memory unit by an index. The first memory unit includes a plurality of entries each having tag information of the index and having a cache tag including a first field and a cache line. In a case where the first control unit receives a first prefetch request for first data of a first logical address, the first control unit stores the prefetched first data in the cache line of a first entry included in the first memory unit, and stores a first value indicating that the first data is the prefetch data in the first field of the first entry. The first control unit maintains the first entry until receiving a read request or a write request for the first logical address from the host.

Hereinafter, embodiments will be described with reference to the drawings. Note that, in the following description, components having substantially the same functions and configurations are denoted by the same reference symbols. In a case where elements having similar configurations are particularly distinguished from each other, different letters or numerals may be added to the end of the same reference symbol.

### 1 First Embodiment

### 1.1 Configuration

### 1.1.1 Configuration of Information Processing System

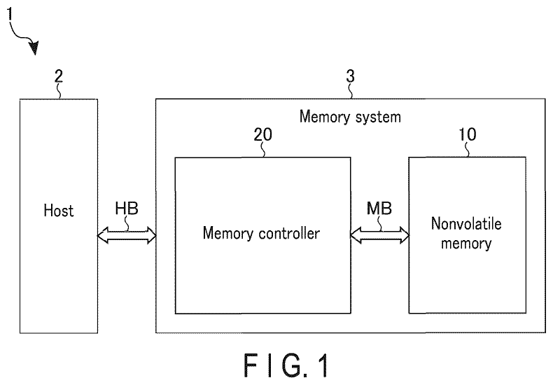

A configuration of an information processing system including a memory system according to a first embodiment will be described with reference to FIG. 1. FIG. 1 is a block diagram illustrating an example of a configuration of an information processing system including a memory system according to a first embodiment. As illustrated in FIG. 1, an information processing system 1 includes a host 2 and a memory system 3. The host 2 and the memory system 3 are coupled through a host bus HB.

The host 2 is a device that controls the memory system 3. The host 2 is a system including a processor and a main memory provided in an information processing device operating as a host, and is configured to be accessible to the memory system 3. Note that the processor configuring the host 2 is, for example, a multi-core processor, and is configured to execute a plurality of programs (application programs) in parallel.

The memory system 3 is, for example, a memory device that stores various data accessed (loaded or stored) by the host 2 that executes the application program. The bus (host bus HB) that couples the host 2 and the memory system 3 is, for example, a CXL bus compliant with the Compute Express Link™ (CXL) standard. The CXL is a standard based on PCI Express (PCIe), and the memory system 3 is accessed from the host 2 according to a protocol that can be accessed by a load command or a store command to a PCIe device called CXL.mem, for example. In the description of the present specification, a load command will be described as a “read request from the host (or simply a read request)”, and a store command will be described as a “write request from the host (or simply a write request)”.

In the present embodiment, the memory system 3 coupled to the host 2 through the CXL bus will be mainly described, but the memory system 3 may be a memory device coupled to the host 2 through a bus conforming to another standard.

The memory system 3 includes a nonvolatile memory, and has intermediate performance between a main memory mainly including a dynamic random access memory (DRAM) and a storage device (for example, a solid state drive (SSD) or the like) including a NAND flash memory. Specifically, the storage capacity of the memory system 3 is larger than that of the main memory, and the access speed to the memory system 3 is higher than that of the storage device. In the present embodiment, with the use of such a memory system 3, it is possible to substantially increase the capacity of the main memory. However, since the memory system 3 has a longer latency (delay time) at the time of reading data from the nonvolatile memory than the DRAM mainly configuring the main memory, a mechanism for improving the read performance of the memory system 3 is required.

The host 2 and the memory system 3 are configured to communicate data of 64 bytes (B) at minimum. Hereinafter, the minimum data transfer unit in the data communication between the host 2 and the memory system 3 is also referred to as “access granularity”.

The host 2 manages a logical address space with a logical address LA corresponding to the access granularity. The logical address space is a memory address space used by the host 2 to access the memory system 3. In a case where the access granularity is 64B (=2⁶B) and the capacity (that is, the capacity of the memory system 3 visible from the host 2) of the logical address space is 256 GB (=2³⁸B), the logical address space is expressed by the logical address LA of 32 (=38−6) bits or more. In the following description, it is assumed that the bit width of the logical address LA is K bits (K is an integer of 2 or more).

### 1.1.2 Configuration of Memory System

Next, an internal configuration of the memory system 3 will be described. As illustrated in FIG. 1, the memory system 3 includes a nonvolatile memory 10 and a memory controller 20. The nonvolatile memory 10 and the memory controller 20 are coupled through a memory bus MB. Communication between the nonvolatile memory 10 and the memory controller 20 conforms to, for example, a single data rate (SDR) interface, a toggle double data rate (DDR) interface, or an open NAND flash interface (ONFI).

The nonvolatile memory 10 includes, for example, one or a plurality of NAND chips (NAND flash memories). The nonvolatile memory 10 has a physical memory area associated with a physical address space. The physical address space is an address space indicating a plurality of storage locations on the physical memory area in the nonvolatile memory 10 (one or a plurality of NAND chips). The physical address PA is an address used by the memory controller 20 to access the physical address space. Hereinafter, a case where the nonvolatile memory 10 includes a plurality of NAND chips will be described as an example.

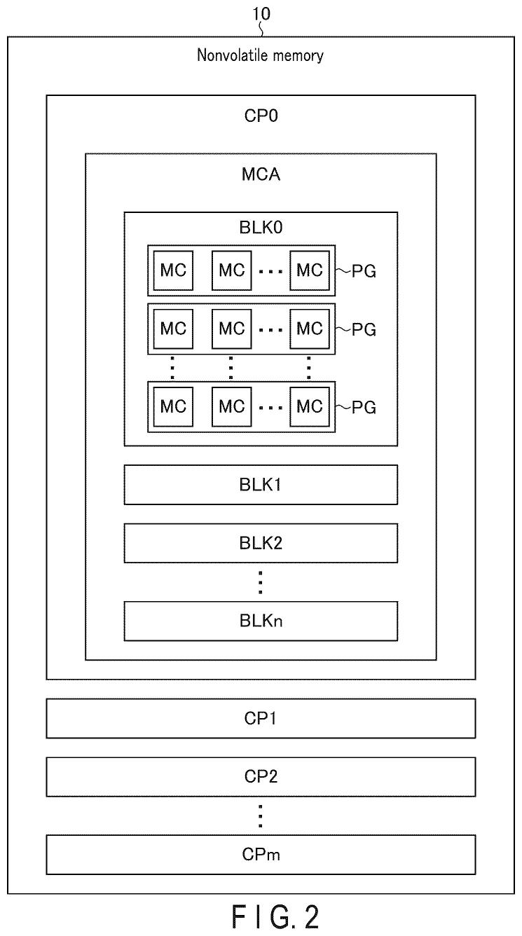

FIG. 2 is a block diagram illustrating an example of a configuration of the nonvolatile memory 10. As illustrated in FIG. 2, the nonvolatile memory 10 includes a plurality of NAND chips CP0 to CPm (m is an integer of 1 or more). Hereinafter, in a case where the NAND chips CP0 to CPm are not distinguished, they are simply referred to as NAND chips CP. Each of the NAND chips CP includes a memory cell array MCA. The memory cell array MCA includes a plurality of blocks BLK0 to BLKn (n is an integer of 1 or more). Hereinafter, in a case where the blocks BLK0 to BLKn are not distinguished, they are simply referred to as a block BLK. Each of the plurality of blocks BLK includes a plurality of pages PG. Each of the plurality of pages PG includes a plurality of memory cells MC. The plurality of memory cells MC stores data in a nonvolatile manner. The block BLK is, for example, a data erasing unit. The page PG is, for example, a unit of writing and reading data. The size of the page PG is, for example, 4 KB or 16 KB.

The memory controller 20 will be described with reference to FIG. 1 again. The memory controller 20 includes, for example, an integrated circuit such as a system-on-a-chip (SoC). The memory controller 20 controls the nonvolatile memory 10 based on a request from the host 2. Specifically, upon receiving a write request WR from the host 2, the memory controller 20 writes data to be written (write data WD) to the nonvolatile memory 10. Upon receiving a read request RR from the host 2, the memory controller 20 reads data to be read (read data RD) from the nonvolatile memory 10 and transmits the read data to the host 2. Upon receiving a prefetch (pre-read) request PR from the host 2, the memory controller 20 executes a prefetch process. The prefetch process is a process of reading data in which the read request RR is expected to come from the host 2 or data in which the read request RR is likely to come therefrom, from the nonvolatile memory 10 in advance before the read request RR comes and storing the data in the cache memory. Hereinafter, the data read by the prefetch process is referred to as “data to be previously read (prefetch data PD)”.

Note that the memory controller 20 may execute internal processing without depending on a request from the host 2. For example, the memory controller 20 may execute the prefetch process by internal processing. Examples of other internal processing include a garbage collection (GC) process. The GC process is a process of writing valid data fragmentarily stored in one or more blocks BLK back to one free block BLK (block BLK in which valid data is not stored), thereby releasing the one or more blocks BLK in which valid data is fragmentarily stored as the free block BLK.

### 1.1.3 Hardware Configuration of Memory Controller

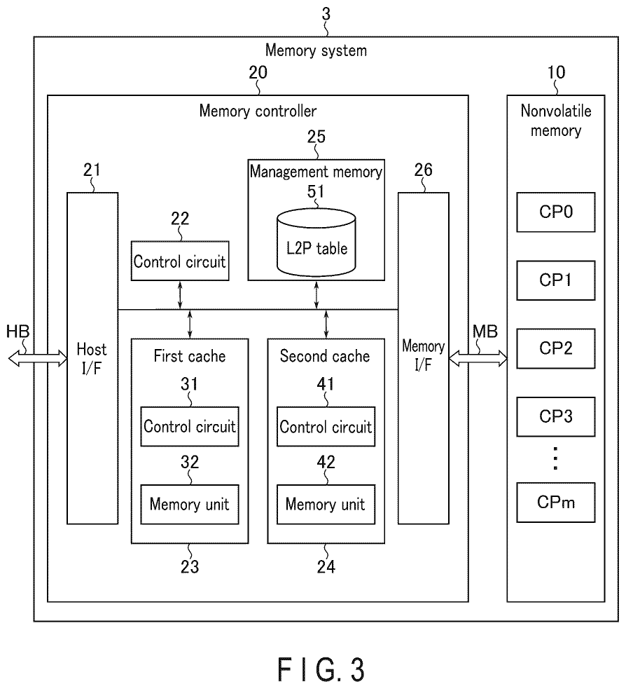

Next, a hardware configuration of the memory controller 20 will be described with reference to FIG. 3. FIG. 3 is a block diagram illustrating an example of a hardware configuration of the memory controller 20. FIG. 3 also illustrates the nonvolatile memory 10. As illustrated in FIG. 3, the memory controller 20 includes a host interface circuit (host I/F) 21, a control circuit 22, a first cache 23, a second cache 24, a management memory 25, and a memory interface circuit (memory I/F) 26. The Function of each part of the memory controller 20 may be implemented by dedicated hardware, a processor which executes programs, or a combination of them. The memory controller 20 also performs communication with the host 2.

The host interface circuit 21 is hardware that manages communication between the memory controller 20 and the host 2. The host interface circuit 21 is coupled to the host 2 through the host bus HB.

The control circuit 22 is a circuit that controls the entire memory controller 20. The control circuit 22 includes, for example, a processor such as a central processing unit (CPU), a read only memory (ROM), and a random access memory (RAM). The processor controls the entire operation of the memory controller 20 by executing a program (firmware) stored in the ROM. The ROM is a nonvolatile memory. The ROM stores a program such as firmware. The RAM is a volatile memory. The RAM is used as a work area of the processor.

The first cache 23 is, for example, a cache memory. As illustrated in FIG. 3, the first cache 23 includes a control circuit 31 and a memory unit 32. The control circuit 31 is a circuit that controls the entire first cache 23. The control circuit 31 includes, for example, a processor such as a CPU, a ROM, and a RAM. The memory unit 32 is, for example, a static random access memory (SRAM). The memory unit 32 stores, for example, prefetch data PD and read data RD. That is, the memory unit 32 (the first cache 23) is a read-only cache. Details of the memory unit 32 will be described later.

The second cache 24 is, for example, a cache memory. As illustrated in FIG. 3, the second cache 24 includes a control circuit 41 and a memory unit 42. The control circuit 41 is a circuit that controls the entire second cache 24. The control circuit 41 includes, for example, a processor such as a CPU, a ROM, and a RAM. The memory unit 42 is, for example, a DRAM. The memory unit 42 stores, for example, prefetch data PD, read data RD, and write data WD. That is, the memory unit 42 (second cache 24) is a read/write cache. Details of the memory unit 42 will be described later.

Here, the first cache 23 and the second cache 24 have different latencies required for reading and writing due to a difference in memory elements. Specifically, the first cache 23 is configured to operate faster with a shorter latency than the second cache 24.

The management memory 25 temporarily stores system data for managing the nonvolatile memory 10. The system data is, for example, an L2P table 51. The L2P table 51 is a table that maps (translates) the logical address LA and the physical address PA. Details of the L2P table 51 will be described later. In addition, the management memory 25 may be used to temporarily store transfer data to the nonvolatile memory 10 or from the nonvolatile memory 10 in units of read or write of the nonvolatile memory 10.

The memory interface circuit 26 is hardware that manages communication between the memory controller 20 and the nonvolatile memory 10. The memory interface circuit 26 is coupled to the nonvolatile memory 10 through the memory bus MB.

### 1.1.4 Configuration of L2P Table

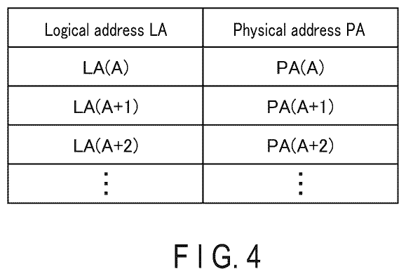

The configuration of the L2P table 51 will be described with reference to FIG. 4. FIG. 4 is a diagram illustrating an example of a configuration of the L2P table 51. As illustrated in FIG. 4, the L2P table 51 includes a plurality of entries. Each entry includes a logical address LA and a physical address PA corresponding to the logical address LA. For example, the L2P table 51 is managed in units of 256B configured by four sequential data in the order of addresses with respect to 64B data which is the access granularity. In this manner, a management unit in which data of a plurality of access granularities is collected is referred to as an “L2P management size”. Each of the plurality of entries is uniquely identified by a corresponding logical address LA. In the example of FIG. 4, a logical address LA (A) corresponds to a physical address PA (A). A logical address LA (A+1) corresponds to a physical address PA (A+1). A logical address LA (A+2) corresponds to a physical address PA (A+2).

The L2P table 51 is stored, for example, in a management data area of the memory cell array MCA in an arbitrary NAND chip CP included in the nonvolatile memory 10. For example, the L2P table 51 is loaded into the management memory 25 by the memory controller 20 immediately after the power is turned on. The L2P table 51 loaded into the management memory 25 is updated by the memory controller 20, for example, in a case where the physical address PA corresponding to the logical address LA is allocated based on the write request WR from the host 2 or in a case where the GC process is performed. In a case where the L2P table 51 of the management memory 25 is updated, the L2P table 51 of the management data area in the nonvolatile memory 10 is updated by the memory controller 20 at an arbitrary timing.

### 1.1.5 Configuration of Memory Unit of First Cache

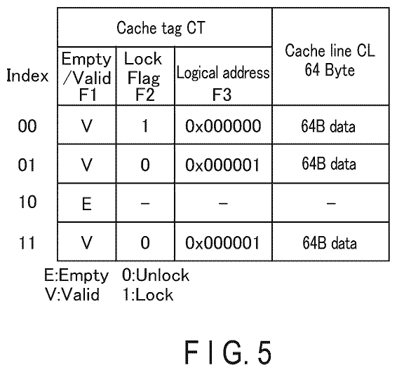

The configuration of the memory unit 32 of the first cache 23 will be described with reference to FIG. 5. FIG. 5 is a diagram illustrating an example of a configuration of the memory unit 32. As illustrated in FIG. 5, the memory unit 32 includes a plurality of entries. Each entry includes a cache tag CT and a cache line CL. The cache tag CT is an area for storing various tag information. The cache line CL is an area for storing the prefetch data PD and the read data RD. A line size of the cache line CL is, for example, 64B. That is, the cache line CL stores 64B data.

In the present embodiment, for example, a plurality of logical addresses LA designated by the host 2 is grouped by lower two bits (“00”, “01”, “10”, and “11”) of each of the logical addresses LA, and each group is allocated to one entry of the memory unit 32. That is, the memory unit 32 includes four entries. Each entry manages lower two bits of the logical address LA as an index number. In this manner, each of the plurality of logical addresses LA designated by the host 2 is mapped to the memory unit 32 by an index.

The cache tag CT includes an E/V field F1, a Lock flag field F2, and a logical address field F3.

The E/V field F1 is a field for storing information indicating whether or not there is data in the cache line CL. In a case where there is no data in the cache line CL, “E” (Empty) is stored in the E/V field F1. In a case where there is data in the cache line CL, “V” (Valid) is stored in the E/V field F1.

The Lock flag field F2 is a field for storing information indicating whether or not there is prefetch data PD in the cache line CL. In a case where there is no data in the cache line CL (Empty), the Lock flag field F2 is in a state where a value thereof is not set (−). In a case where there is data in the cache line CL (Valid) and the data is the read data RD, “0” (Unlock) is stored in the Lock flag field F2. “0” indicates that the data is not the prefetch data PD. In a case where there is data in the cache line CL (Valid) and the data is prefetch data PD, “1” (Lock) is stored in the Lock flag field F2. “1” indicates that the data is the prefetch data PD. In the following description, a state in which there is data in the cache line CL (Valid) and the data is the prefetch data PD (Lock) will be referred to as a Lock state by omitting the Valid state.

The logical address field F3 is a field for storing an upper bit value obtained by removing the address bit used for the index number from the logical address LA. In the example of FIG. 5, upper bits ((K−2) bits) of the logical address LA except lower two bits are stored in the logical address field F3.

In the example of FIG. 5, in the entry having the tag information of the index “00”, 64B data is stored in the cache line CL (Lock), “V” is stored in the E/V field F1, “1” is stored in the Lock flag field F2, and “0x000000” is stored in the logical address field F3. That is, the prefetch data PD is stored in the entry to which the address value “0x00000000” (=logical address LA) obtained by concatenating the address value of the logical address field F3 and the index number is allocated.

In the entry having the tag information of the index “01”, 64B data is stored (Valid) in the cache line CL, “V” is stored in the E/V field F1, “0” is stored in the Lock flag field F2, and “0x000001” is stored in the logical address field F3. That is, the read data RD is stored in the entry to which the address value “0x00000101” (=logical address LA) obtained by concatenating the address value of the logical address field F3 and the index number is allocated.

In the entry having the tag information of the index “10”, the cache line CL is in a state where the data is not set (−) (Empty), “E” is stored in the E/V field F1, and the Lock flag field F2 and the logical address field F3 are in a state where the values are not set (−). That is, no data is stored in the entry having the tag information of the index “10”.

In the entry having the tag information of the index “11”, 64B data is stored (Valid) in the cache line CL, “V” is stored in the E/V field F1, “0” is stored in the Lock flag field F2, and “0x000001” is stored in the logical address field F3. That is, the read data RD is stored in the entry to which the address value “0x00000111” (=logical address LA) obtained by concatenating the address value of the logical address field F3 and the index number is allocated.

In the example of FIG. 5, as a method of allocating the plurality of logical addresses LA to the entries included in the memory unit 32, an allocation method by the direct map method (1-way set associative method) is illustrated, but an allocation method by the L-way set associative method (L is an integer of 2 or more) may be used. In addition, the number of index numbers is not limited to four, and may be increased to any number (a power of two).

Hereinafter, in the entry of the memory unit 32, a state in which the value of the field F1 of the cache tag CT is “E” is also referred to as “the entry is in an Empty state”. A state in which the value of the field F1 of the cache tag CT is “V” and the value of the field F2 of the cache tag CT is “0” is also referred to as “the entry is in a Valid state”. A state in which the value of the field F1 of the cache tag CT is “V” and the value of the field F2 of the cache tag CT is “1” is also referred to as “the entry is in a Lock state”.

### 1.1.6 Configuration of Memory Unit of Second Cache

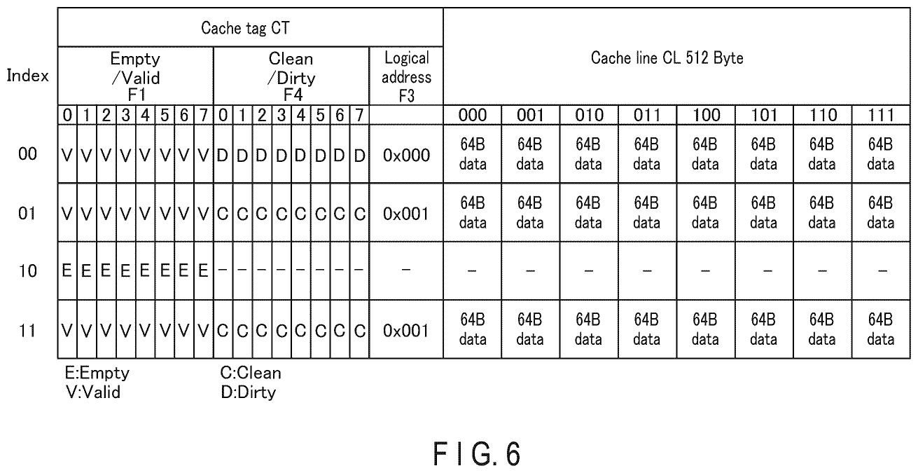

The configuration of the memory unit 42 of the second cache 24 will be described with reference to FIG. 6. FIG. 6 is a diagram illustrating an example of a configuration of the memory unit 42. As illustrated in FIG. 6, the memory unit 42 includes a plurality of entries. Each entry includes a cache tag CT and a cache line CL. The cache line CL is an area for storing the prefetch data PD, the read data RD, and the write data WD. The line size of the cache line CL is, for example, 512B. That is, one cache line CL stores eight pieces of 64B data. Each of the eight pieces of 64B data corresponds to the lower three bits (“000”, “001”, “010”, “011”, “100”, “101”, “110”, and “111”) of the logical address LA.

In the present embodiment, for example, a plurality of logical addresses LA is grouped by upper two bits (“00”, “01”, “10”, and “11”) among lower five bits of each of the logical addresses LA, and each group is allocated to one entry of the memory unit 42. That is, the memory unit 42 includes four entries. Each entry manages the upper two bits of the lower five bits of the logical address LA as an index number. In this manner, each of the plurality of logical addresses LA designated by the host 2 is mapped to the memory unit 42 by the index.

The cache tag CT includes the E/V field F1, a C/D field F4, and the logical address field F3.

The E/V field F1 is similar to the memory unit 32 of the first cache 23 except that it includes eight subfields 0 to 7. The eight subfields 0 to 7 correspond to the lower three bits of the logical address LA, respectively.

The C/D field F4 is a field for storing information indicating whether or not the data written in the nonvolatile memory 10 and the data stored in the memory unit 42 match. In a case where both match (Clean), “C” (Clean) is stored in the C/D field F4. That is, in this case, the stored data is in a Clean state. In a case where the two do not match (Dirty), “D” (Dirty) is stored in the C/D field F4. That is, in this case, the stored data is in a Dirty state. The C/D field F4 includes eight subfields 0 to 7. The eight subfields 0 to 7 correspond to the lower three bits of the logical address LA, respectively.

The logical address field F3 is similar to the memory unit 32 of the first cache 23. In the example of FIG. 6, upper bits ((K−5) bits) of the logical address LA except lower five bits are stored in the logical address field F3.

In the example of FIG. 6, in the entry having the tag information of the index “00”, eight pieces of 64B data are stored (Dirty) in the cache line CL, “V” is stored in each of the subfields 0 to 7 of the E/V field F1, “D” is stored in each of the subfields 0 to 7 of the C/D field F4, and “0x000” is stored in the logical address field F3. That is, the write data WD is stored in the Dirty state in the entry to which the address values “0x00000000” to “0x00000111” (=logical address LA) obtained by concatenating the address value of the logical address field F3, the index number, and the lower three bits of the logical address LA are allocated.

In the entry having the tag information of the index “01”, eight pieces of 64B data are stored in the cache line CL (Clean), “V” is stored in each of the subfields 0 to 7 of the E/V field F1, “C” is stored in each of the subfields 0 to 7 of the C/D field F4, and “0x001” is stored in the logical address field F3. That is, the prefetch data PD, the read data RD, or the write data WD is stored in the Clean state in the entry to which the address values “0x00101000” to “0x00101111” (=logical address LA) obtained by concatenating the address value of the logical address field F3, the index number, and the lower three bits of the logical address LA are allocated.

In the entry having the tag information of the index “10”, the cache line CL is in a state where data is not set (−) (Empty), “E” is stored in each of the subfields 0 to 7 of the E/V field F1, and each of the subfields 0 to 7 of the C/D field F4 and the logical address field F3 are in a state where values are not set (−). That is, no data is stored in the entry having the tag information of the index “10”.

In the entry having the tag information of the index “11”, eight pieces of 64B data are stored in the cache line CL (Clean), “V” is stored in each of the subfields 0 to 7 of the E/V field F1, “C” is stored in each of the subfields 0 to 7 of the C/D field F4, and “0x001” is stored in the logical address field F3. That is, the prefetch data PD, the read data RD, or the write data WD is stored in the Clean state in the entry to which the address values “0x00111000” to “0x00111111” (=logical address LA) obtained by concatenating the address value of the logical address field F3, the index number, and the lower three bits of the logical address LA are allocated.

In the example of FIG. 6, as a method of allocating the plurality of logical addresses LA to the entries included in the memory unit 42, an allocation method by the direct map method (1-way set associative method) is illustrated, but an allocation method by the L-way set associative method (L is an integer of 2 or more) may be used. In addition, the number of index numbers is not limited to four, and may be increased to any number (a power of two).

Hereinafter, in the entry of the memory unit 42, a state in which the value of the subfield corresponding to the logical address LA of the field F1 of the cache tag CT is “E” is also referred to as “the entry is in the Empty state”. A state in which the value of the subfield corresponding to the logical address LA of the field F1 of the cache tag CT is “V” and the value of the subfield corresponding to the logical address LA of the field F4 of the cache tag CT is “C” is also referred to as “the entry is in the Clean state”. A state in which the value of the subfield corresponding to the logical address LA of the field F1 of the cache tag CT is “V” and the value of the subfield corresponding to the logical address LA of the field F4 of the cache tag CT is “D” is also referred to as “the entry is in the Dirty state”.

### 1.1.7 Functional Configuration of Memory Controller

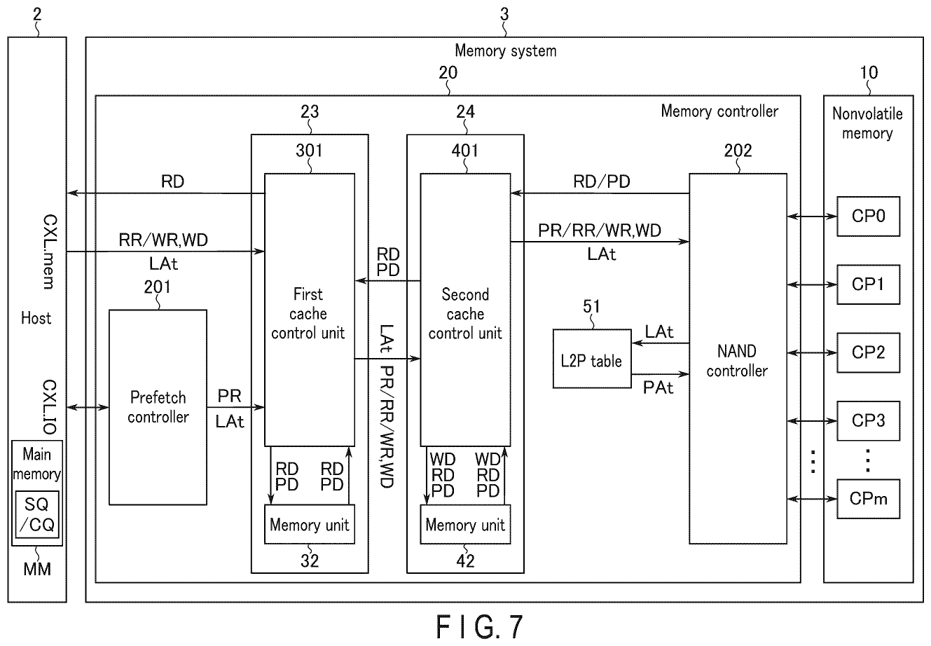

Next, a functional configuration of the memory controller 20 will be described with reference to FIG. 7. FIG. 7 is a block diagram illustrating an example of a functional configuration of the memory controller 20. As illustrated in FIG. 7, the memory controller 20 includes a prefetch controller 201 and a NAND controller 202 as functional blocks. The first cache 23 includes a first cache control unit 301 as a functional block. The second cache 24 includes a second cache control unit 401 as a functional block. The control circuit 22 of the memory controller 20 functions as the prefetch controller 201 and the NAND controller 202. The control circuit 31 of the first cache 23 functions as the first cache control unit 301. The control circuit 41 of the second cache 24 functions as the second cache control unit 401. In FIG. 7, illustration of functional blocks corresponding to the host interface circuit 21, the management memory 25, and the memory interface circuit 26 of the memory controller 20 is omitted.

Hereinafter, the logical address LA and the physical address PA to be previously read, read, and written are respectively referred to as a “target logical address LAt” and a “target physical address PAt”. In the memory unit 32, an entry having an index corresponding to the target logical address LAt is referred to as a “target entry E3t”. In the memory unit 42, an entry having an index corresponding to the target logical address LAt is referred to as a “target entry E4t”.

### (Prefetch Controller 201)

The prefetch controller 201 controls a prefetch process. In a main memory MM in the host 2, a submission queue SQ and a completion queue CQ for pre-read that can be controlled by user software of the host 2 are configured. The prefetch controller 201 periodically reads the submission queue SQ using the CXL.IO protocol to confirm the presence of a new entry. In a case of detecting that the prefetch request PR is entered in the submission queue SQ, the prefetch controller 201 transmits the prefetch request PR and the target logical address LAt to the first cache control unit 301. That is, in the present embodiment, the prefetch request PR is transmitted to the first cache control unit 301 by the prefetch controller 201 based on designation of the prefetch process by the user. By this, the memory system 3 can control the prefetch process based on the designation of the prefetch process by the user. The prefetch request PR is issued to the data before the read request RR from the host 2, so that the data can be stored in the first cache 23. By this, a read latency for the read request RR for the data can be shortened from a read time to the nonvolatile memory 10 to a read time to the first cache 23, and the read performance of the memory system 3 can be greatly improved. Note that the submission queue SQ and the completion queue CQ are generally configured on the main memory MM, but are not limited thereto.

### (First Cache Control Unit 301)

The first cache control unit 301 controls the memory unit 32. Hereinafter, a case where the first cache control unit 301 receives each of the prefetch request PR, the read request RR, and the write request WR will be described.

### (Case of Receiving Prefetch Request PR)

The first cache control unit 301 receives the prefetch request PR and the target logical address LAt from the prefetch controller 201. The first cache control unit 301 searches the memory unit 32 based on the target logical address LAt.

In a case where no data is stored in the cache line CL of the target entry E3t (the target entry E3t is in the Empty state), a cache miss occurs, and the first cache control unit 301 transmits the prefetch request PR and the target logical address LAt to the second cache control unit 401. The first cache control unit 301 receives the data of the target logical address LAt read from the second cache 24 or the nonvolatile memory 10 from the second cache control unit 401, and stores the received data in the target entry E3t as the prefetch data PD in the Lock state.

In a case where the data of the target logical address LAt is stored in the cache line CL of the target entry E3t (the target entry E3t is in the Valid state or the Lock state), a cache hit occurs, and the first cache control unit 301 performs the following operation. In a case where the data of the target entry E3t is in an Unlock state, the first cache control unit 301 updates the data to the Lock state. In a case where the data of the target entry E3t is in the Lock state, the first cache control unit 301 maintains the data in the Lock state.

In a case where data of another logical address LA is stored in the cache line CL of the target entry E3t (the target entry E3t is in the Valid state or the Lock state), a cache miss occurs, and the first cache control unit 301 evicts the data of the target entry E3t and transmits the data to the second cache control unit 401. Thereafter, similarly to the case where the target entry E3t is in the Empty state, the first cache control unit 301 reads the prefetch data PD and stores the prefetch data PD in the target entry E3t in the Lock state.

### (Case of Receiving Read Request RR)

The first cache control unit 301 receives the read request RR and the target logical address LAt from the host 2 using a CXL.mem protocol. The first cache control unit 301 searches the memory unit 32 based on the target logical address LAt.

In a case where the data is not stored in the cache line CL of the target entry E3t (the target entry E3t is in the Empty state), a cache miss occurs, and the first cache control unit 301 transmits the read request RR and the target logical address LAt to the second cache control unit 401. The first cache control unit 301 receives the data of the target logical address LAt read from the second cache 24 or the nonvolatile memory 10 from the second cache control unit 401, transmits the received data to the host 2 as read data RD, and stores the data in the target entry E3t in the Unlock state.

In a case where the data of the target logical address LAt is stored in the cache line CL of the target entry E3t (the target entry E3t is in the Valid state or the Lock state), a cache hit occurs, and the first cache control unit 301 transmits the data of the target entry E3t to the host 2 as the read data RD. In a case where the data of the target entry E3t is in the Unlock state, the first cache control unit 301 maintains the data in the Unlock state. In a case where the data of the target entry E3t is in the Lock state, the first cache control unit 301 clears the target entry E3t.

In a case where data of another logical address LA is stored in the cache line CL of the target entry E3t (the target entry E3t is in the Valid state or the Lock state), a cache miss occurs, and the first cache control unit 301 reads the read data RD and transmits the read data RD to the host 2 similarly to the case where the target entry E3t is in the Empty state. In a case where the data of the target entry E3t is in the Unlock state, the first cache control unit 301 evicts the data from the target entry E3t, transmits the data to the second cache control unit 401, and then stores the read data RD in the target entry E3t in the Unlock state. In a case where the data of the target entry E3t is in the Lock state, the first cache control unit 301 maintains the data in the Lock state.

### (Case of Receiving Write Request WR)

The first cache control unit 301 receives the write request WR, the target logical address LAt, and the write data WD from the host 2 using the CXL.mem protocol. The first cache control unit 301 transmits the write request WR, the target logical address LAt, and the write data WD to the second cache control unit 401. The first cache control unit 301 searches the memory unit 32 based on the target logical address LAt.

In a case where no data is stored in the cache line CL of the target entry E3t (the target entry E3t is in the Empty state), the first cache control unit 301 maintains the target entry E3t in the Empty state.

In a case where the data of the target logical address LAt is stored in the cache line CL of the target entry E3t (the target entry E3t is in the Valid state or the Lock state), the first cache control unit 301 clears the target entry E3t.

In a case where data of another logical address LA is stored in the cache line CL of the target entry E3t (the target entry E3t is in the Valid state or the Lock state), the first cache control unit 301 maintains the target entry E3t.

Note that the first cache control unit 301 does not store the write data WD in the target entry E3t.

### (Second Cache Control Unit 401)

The second cache control unit 401 controls the memory unit 42. Hereinafter, a case where the second cache control unit 401 receives each of the prefetch request PR, the read request RR, and the write request WR will be described.

### (Case of Receiving Prefetch Request PR)

The second cache control unit 401 receives the prefetch request PR and the target logical address LAt from the first cache control unit 301. The second cache control unit 401 searches the memory unit 42 based on the target logical address LAt.

In a case where no data is stored in the target entry E4t (the target entry E4t is in the Empty state), a cache miss occurs, and the second cache control unit 401 transmits the prefetch request PR and the target logical address LAt to the NAND controller 202. The NAND controller 202 refers to the L2P table 51 and translates the target logical address LAt to the target physical address PAt. The second cache control unit 401 receives the data of the target physical address PAt read from the nonvolatile memory 10 from the nonvolatile memory 10, and transmits the received data to the first cache control unit 301 as prefetch data PD. At this time, the second cache control unit 401 may store the prefetch data PD in the target entry E4t.

In a case where the data of the target logical address LAt is stored in the target entry E4t (the target entry E4t is in the Clean state or the Dirty state), a cache hit occurs, and the second cache control unit 401 transmits the data of the target entry E4t to the first cache control unit 301 as the prefetch data PD.

In a case where data of another logical address LA is stored in the target entry E4t (the target entry E4t is in the Clean state or the Dirty state), a cache miss occurs, and the second cache control unit 401 reads the prefetch data PD from the nonvolatile memory 10 and transmits the prefetch data PD to the first cache control unit 301, similarly to the case where the target entry E4t is in the Empty state. At this time, the second cache control unit 401 may store the prefetch data PD in the target entry E4t. In a case where the data of the target entry E4t is in the Dirty state, the second cache control unit 401 evicts the data from the target entry E4t and performs a writeback process. That is, the second cache control unit 401 transmits the write request WR, the target logical address LAt, and the data to the NAND controller 202. Thereafter, the second cache control unit 401 stores the prefetch data PD in the target entry E4t. In a case where the data of the target entry E4t is in the Clean state, the second cache control unit 401 clears the target entry E4t and then stores the prefetch data PD in the target entry E4t.

### (Case of Receiving Read Request RR)

The second cache control unit 401 receives the read request RR and the target logical address LAt from the first cache control unit 301. The second cache control unit 401 searches the memory unit 42 based on the target logical address LAt.

In a case where the data is not stored in the target entry E4t (the target entry E4t is in the Empty state), a cache miss occurs, and the second cache control unit 401 transmits the read request RR and the target logical address LAt to the NAND controller 202. The NAND controller 202 refers to the L2P table 51 and translates the target logical address LAt to the target physical address PAt. The second cache control unit 401 receives the data of the target physical address PAt read from the nonvolatile memory 10 from the nonvolatile memory 10, and transmits the received data to the first cache control unit 301 as read data RD. At this time, the second cache control unit 401 may store the read data RD in the target entry E4t.

In a case where the data of the target logical address LAt is stored in the target entry E4t (the target entry E4t is in the Clean state or the Dirty state), a cache hit occurs, and the second cache control unit 401 transmits the data of the target entry E4t to the first cache control unit 301 as the read data RD.

In a case where data of another logical address LA is stored in the target entry E4t (the target entry E4t is in the Clean state or the Dirty state), a cache miss occurs, and the second cache control unit 401 reads the read data RD from the nonvolatile memory 10 and transmits the read data RD to the first cache control unit 301, similarly to the case where the target entry E4t is in the Empty state. At this time, the second cache control unit 401 may store the read data RD in the target entry E4t. In a case where the data of the target entry E4t is in the Dirty state, the second cache control unit 401 performs the writeback process similarly to the case where the prefetch request PR is received. Thereafter, the second cache control unit 401 stores the read data RD in the target entry E4t. In a case where the data of the target entry E4t is in the Clean state, the second cache control unit 401 clears the target entry E4t and then stores the read data RD in the target entry E4t.

### (Case of Receiving Write Request WR)

The second cache control unit 401 receives the write request WR, the target logical address LAt, and the write data WD from the first cache control unit 301. The second cache control unit 401 stores the received write data WD in the target entry E4t, and sets the cache tag CT to the Dirty state. Thereafter, in a case where the write back occurs at the time of receiving the read request RR, the prefetch request PR, or the write request WR of another logical address LA with respect to the target entry E4t, the second cache control unit 401 transmits the write request WR, the target logical address LAt, and the data of the target entry E4t to the NAND controller 202.

Hereinafter, each state of the target entry E4t will be described. In a case where the second cache control unit 401 receives the write request WR, the target logical address LAt, and the write data WD from the first cache control unit 301, the second cache control unit 401 searches the memory unit 42 based on the target logical address LAt.

In a case where no data is stored in the target entry E4t (the target entry E4t is in the Empty state), the second cache control unit 401 stores the write data WD in the target entry E4t in the Dirty state. Thereafter, in a case where the write back occurs at the time of receiving the read request RR, the prefetch request PR, or the write request WR of another logical address LA with respect to the target entry E4t, the second cache control unit 401 transmits the write request WR, the target logical address LAt, and the data of the target entry E4t to the NAND controller 202.

In a case where the data of the target logical address LAt is stored in the target entry E4t (the target entry E4t is in the Clean state or the Dirty state), the second cache control unit 401 clears the target entry E4t and then stores the write data WD in the target entry E4t in the Dirty state. Thereafter, in a case where the write back occurs at the time of receiving the read request RR, the prefetch request PR, or the write request WR of another logical address LA with respect to the target entry E4t, the second cache control unit 401 transmits the write request WR, the target logical address LAt, and the data of the target entry E4t to the NAND controller 202.

In a case where data of another logical address LA is stored in the target entry E4t (the target entry E4t is in the Clean state or the Dirty state), the second cache control unit 401 performs the following operation. In a case where the data of the target entry E4t is in the Dirty state, the second cache control unit 401 performs the writeback process similarly to the case of receiving the prefetch request PR. Thereafter, the second cache control unit 401 stores the write data WD in the target entry E4t in the Dirty state. In a case where the data of the target entry E4t is in the Clean state, the second cache control unit 401 clears the target entry E4t and then stores the write data WD in the target entry E4t in the Dirty state. Thereafter, in a case where the write back occurs at the time of receiving the read request RR, the prefetch request PR, or the write request WR of another logical address LA with respect to the target entry E4t, the second cache control unit 401 transmits the write request WR, the target logical address LAt, and the data of the target entry E4t to the NAND controller 202.

### (NAND Controller 202)

The NAND controller 202 controls the nonvolatile memory 10. Hereinafter, a case where the NAND controller 202 receives each of the prefetch request PR, the read request RR, and the write request WR will be described.

### (Case of Receiving Prefetch Request PR)

The NAND controller 202 receives the prefetch request PR and the target logical address LAt from the second cache control unit 401. The NAND controller 202 refers to the L2P table 51 and translates the target logical address LAt to the target physical address PAt. The NAND controller 202 transmits the command of the prefetch request PR and the target physical address PAt to the nonvolatile memory 10. The nonvolatile memory 10 executes the read operation based on the command and the target physical address PAt. The NAND controller 202 transmits the data of the target physical address PAt read from the nonvolatile memory 10 to the second cache control unit 401 as the prefetch data PD.

### (Case of Receiving Read Request RR)

The NAND controller 202 receives the read request RR and the target logical address LAt from the second cache control unit 401. The NAND controller 202 refers to the L2P table 51 and translates the target logical address LAt to the target physical address PAt. The NAND controller 202 transmits the command of the read request RR and the target physical address PAt to the nonvolatile memory 10. The nonvolatile memory 10 executes the read operation based on the command and the target physical address PAt. The NAND controller 202 transmits the data of the target logical address PAt read from the nonvolatile memory 10 to the second cache control unit 401 as read data RD.

### (Case of Receiving Write Request WR)

The NAND controller 202 receives the write request WR and the write data WD from the second cache control unit 401. The NAND controller 202 refers to the L2P table 51 and translates the target logical address LAt to the target physical address PAt. The NAND controller 202 transmits the command of the write request WR, the target physical address PAt, and the write data WD to the nonvolatile memory 10. The nonvolatile memory 10 executes the write operation based on the command, the target physical address PAt, and the write data WD. After the NAND controller 202 temporarily stores the write data WD in the management memory 25, the NAND controller 202 may transfer the write data WD from the management memory 25 to the nonvolatile memory 10.

### 1.2 Operation of First Cache

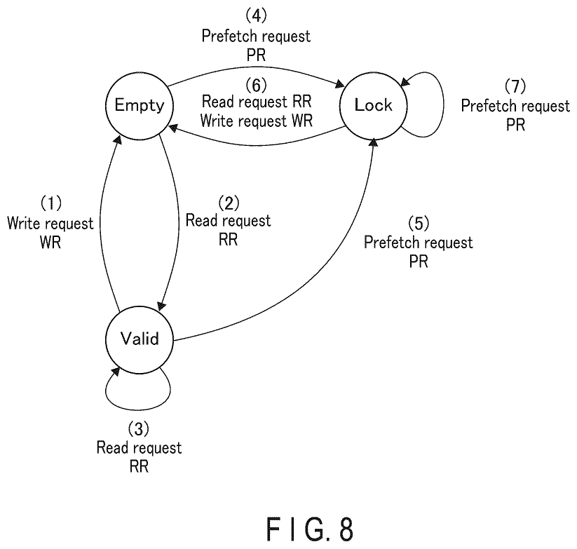

Next, the operation of the first cache 23 will be described with reference to FIGS. 5 and 8. FIG. 8 is a diagram illustrating an example of a state transition of the cache tag CT of the target entry E3t of the memory unit 32. In FIG. 8, “Empty” indicates a state in which a value of the field F1 of the cache tag CT of the target entry E3t is “E”. “Valid” indicates a state in which the value of the field F1 of the cache tag CT of the target entry E3t is “V” and the value of the field F2 is “0”. “Lock” indicates a state in which the value of the field F1 of the cache tag CT of the target entry E3t is “V” and the value of the field F2 is “1”.

First, a case where the first cache control unit 301 of the first cache 23 receives the prefetch request PR for the data of the target logical address LAt will be described. In this case, the first cache control unit 301 stores the prefetched data in the cache line CL of the target entry E3t included in the memory unit 32, and stores “1” in the field F2 of the target entry E3t. In addition, the first cache control unit 301 maintains the target entry E3t until receiving the read request RR or the write request WR for the target logical address LAt from the host 2. Specific content of the operation is as follows.

Upon receiving the prefetch request PR and the target logical address LAt from the prefetch controller 201, the first cache control unit 301 searches the memory unit 32 and checks the cache tag CT of the target entry E3t.

It is assumed that the target entry E3t is the third entry of the memory unit 32 illustrated in FIG. 5 and the target logical address LAt is X1. In the third entry, the value of the field F1 is “E”. That is, no data is stored in the cache line CL of the third entry (Empty). This is a case where there is no data in the target entry E3t of the memory unit 32, and the data of the target logical address LAt is received from the second cache 24 and stored in the target entry E3t as the prefetch data PD. In this case, the first cache control unit 301 transmits the prefetch request PR and the target logical address LAt (=X1) to the second cache control unit 401. The first cache control unit 301 receives the data of the target logical address LAt (=X1) read from the memory unit 42 or the nonvolatile memory 10 from the second cache control unit 401. In the third entry, the first cache control unit 301 stores the received data in the cache line CL as prefetch data PD, stores “V” in the field F1, and stores “1” in the field F2. The state transition of the cache tag CT of the target entry E3t corresponds to the transition in (4) of FIG. 8.

It is assumed that the target entry E3t is the second entry of the memory unit 32 illustrated in FIG. 5 and the target logical address LAt is X2=0x00000101. In the second entry, the value of the field F1 is “V”, the value of the field F2 is “0”, and the logical address LA corresponding to the stored data is the same as the target logical address LAt (=X2). That is, the data of the target logical address LAt is stored (Valid) in the cache line CL of the second entry, and “1” is not stored in the field F2 of the second entry. This is a case where the data of the target logical address LAt exists in the target entry E3t of the memory unit 32 and is in the Valid state, and the data is stored in the target entry E3t as the prefetch data PD. In this case, the first cache control unit 301 updates the value of the field F2 to “1” in the second entry. The state transition of the cache tag CT of the target entry E3t corresponds to the transition in (5) of FIG. 8.

It is assumed that the target entry E3t is the first entry of the memory unit 32 illustrated in FIG. 5 and the target logical address LAt is X3=0x00000000. In the first entry, the value of the field F1 is “V”, the value of the field F2 is “1”, and the logical address LA corresponding to the stored data is the same as the target logical address LAt (=X3). That is, the data of the target logical address LAt is stored (Lock) in the cache line CL of the first entry, and “1” is stored in the field F2 of the first entry. This is a case where the data of the target logical address LAt exists in the target entry E3t of the memory unit 32 and is in the Lock state, and the data is stored in the target entry E3t as the prefetch data PD. In this case, the first cache control unit 301 maintains the first entry.

It is assumed that the target entry E3t is the second entry of the memory unit 32 illustrated in FIG. 5 and the target logical address LAt is X4=0x00000001. In the second entry, the value of the field F1 is “V”, the value of the field F2 is “0”, and the logical address LA corresponding to the stored data is different from the target logical address LAt (=x4). That is, data of a logical address different from the target logical address LAt is stored (Valid) in the cache line CL of the second entry, and “1” is not stored in the field F2 of the second entry. This is a case where data of another logical address LA exists in the target entry E3t of the memory unit 32 and is in the Valid state, the data is evicted, and the data of the target logical address LAt is received from the second cache 24 and the received data is stored in the target entry E3t as the prefetch data PD. In this case, the first cache control unit 301 evicts the stored data from the second entry, and reads the prefetch data PD similarly to a case where the value of the field F1 is “E”. In the second entry, the first cache control unit 301 stores the prefetch data PD in the cache line CL, stores “V” in the field F1, and stores “1” in the field F2. The state transition of the cache tag CT of the target entry E3t corresponds to the transition in (5) of FIG. 8.

In response to the read request RR from the host 2, the prefetch data PD is preferentially stored in the memory unit 32 so that the data of the memory unit 32 can be transmitted from the first cache 23 to the host 2. Therefore, the cache tag CT of the second entry transitions as (5) in FIG. 8.

It is assumed that the target entry E3t is the first entry of the memory unit 32 illustrated in FIG. 5 and the target logical address LAt is X5=0x00000100. In the first entry, the value of the field F1 is “V”, the value of the field F2 is “1”, and the logical address LA corresponding to the stored data is different from the target logical address LAt (=X5). That is, data of a logical address different from the target logical address LAt is stored (Lock) in the cache line CL of the first entry, and “1” is stored in the field F2 of the first entry. This is a case where data of another logical address LA exists in the target entry E3t of the memory unit 32 and is in the Lock state, the data is evicted, and the data of the target logical address LAt is received from the second cache 24 and the received data is stored in the target entry E3t as the prefetch data PD. In this case, the first cache control unit 301 evicts the stored data from the first entry, and reads the prefetch data PD similarly to a case where the value of the field F1 is “E”. In the first entry, the first cache control unit 301 stores the prefetch data PD in the cache line CL, stores “V” in the field F1, and stores “1” in the field F2. The state transition of the cache tag CT of the target entry E3t corresponds to the transition in (7) of FIG. 8.

In a case where the prefetch request PR is received, it is considered that there is a high possibility that the read request RR for the prefetch data PD comes from the host 2. Therefore, the cache tag CT of the first entry transitions as (7) in FIG. 8. Note that the first entry may be maintained instead of the transition as in (7) of FIG. 8.

Next, a case where the first cache control unit 301 receives the read request RR for the data of the target logical address LAt from the host 2 will be described. Upon receiving the read request RR and the target logical address LAt from the host 2, the first cache control unit 301 searches the memory unit 32 and checks the cache tag CT of the target entry E3t.

It is assumed that the target entry E3t is the third entry of the memory unit 32 illustrated in FIG. 5 and the target logical address LAt is X1. No data is stored in the cache line CL of the third entry (Empty). This is a case where the data does not exist in the target entry E3t of the memory unit 32, and the data of the target logical address LAt is received from the second cache 24 and transmitted to the host 2 as the read data RD. In this case, the first cache control unit 301 transmits the read request RR and the target logical address LAt (=X1) to the second cache control unit 401. The first cache control unit 301 receives the data of the target logical address LAt (=X1) read from the second cache 24 or the nonvolatile memory 10 from the second cache control unit 401. The first cache control unit 301 transmits the received data to the host 2 as read data RD. In the third entry, the first cache control unit 301 stores the received data in the cache line CL as read data RD, stores “V” in the field F1, and stores “0” in the field F2. The state transition of the cache tag CT of the target entry E3t corresponds to the transition of (2) of FIG. 8.

It is assumed that the target entry E3t is the second entry of the memory unit 32 illustrated in FIG. 5 and the target logical address LAt is X2=0x00000101. The data of the target logical address LAt is stored (Valid) in the cache line CL of the second entry, and “1” is not stored in the field F2 of the second entry. This is a case where the data of the target logical address LAt exists in the target entry E3t of the memory unit 32 and is in the Valid state, and the data is transmitted to the host 2 as the read data RD. In this case, the first cache control unit 301 transmits the data of the second entry to the host 2 as read data RD. The first cache control unit 301 maintains the second entry.

It is assumed that the target entry E3t is the first entry of the memory unit 32 illustrated in FIG. 5 and the target logical address LAt is X3=0x00000000. The data of the target logical address LAt is stored (Lock) in the cache line CL of the first entry, and “1” is stored in the field F2 of the first entry. This is a case where the data of the target logical address LAt exists in the target entry E3t of the memory unit 32 and is in the Lock state, and the data is transmitted to the host 2 as the read data RD. In this case, the first cache control unit 301 transmits the data of the first entry to the host 2 as read data RD. In the first entry, the first cache control unit 301 clears the cache line CL, stores “E” in the field F1, and clears the field F2. The state transition of the cache tag CT of the target entry E3t corresponds to the transition in (6) of FIG. 8.

After reading is performed based on the read request RR from the host 2, the read data RD is stored in a cache (not illustrated) in the host 2. Therefore, it is considered that the read request RR for the data from the host 2 to the first cache 23 will not come for a while. Therefore, it is considered that the data may not be stored in the first entry for a while. Therefore, the cache tag CT of the first entry transitions as (6) in FIG. 8.

It is assumed that the target entry E3t is the second entry of the memory unit 32 illustrated in FIG. 5 and the target logical address LAt is X4=0x00000001. Data of a logical address different from the target logical address LAt is stored (Valid) in the cache line CL of the second entry, and “1” is not stored in the field F2 of the second entry. This is a case where the data of another logical address LA exists in the target entry E3t of the memory unit 32 and is in the Valid state, and the data of the target logical address LAt is received from the second cache 24 and transmitted to the host 2 as the read data RD. In this case, the first cache control unit 301 reads the read data RD and transmits the read data RD to the host 2, similarly to the case where the value of the field F1 is “E”. The first cache control unit 301 evicts the stored data from the second entry, stores the read data RD in the cache line CL, stores “V” in the field F1, and stores “0” in the field F2 in the second entry. The state transition of the cache tag CT of the target entry E3t corresponds to the transition of (3) of FIG. 8.

It is assumed that the target entry E3t is the first entry of the memory unit 32 illustrated in FIG. 5 and the target logical address LAt is X5=0x00000100. Data of a logical address different from the target logical address LAt is stored (Lock) in the cache line CL of the first entry, and “1” is stored in the field F2 of the first entry. This is a case where the data of another logical address LA exists in the target entry E3t of the memory unit 32 and is in the Lock state, and the data of the target logical address LAt is received from the second cache 24 and transmitted to the host 2 as the read data RD. In this case, the first cache control unit 301 reads the read data RD and transmits the read data RD to the host 2, similarly to the case where the value of the field F1 is “E”. The first cache control unit 301 maintains the first entry.

In response to the read request RR from the host 2, the prefetch data PD is preferentially stored in the memory unit 32 so that the data of the memory unit 32 can be transmitted from the first cache 23 to the host 2. Therefore, the first entry is maintained.

Next, a case where the first cache control unit 301 receives the write request WR for the target logical address LAt from the host 2 will be described. Upon receiving the write request WR, the target logical address LAt, and the write data WD from the host 2, the first cache control unit 301 transmits the write request WR, the target logical address LAt, and the write data WD to the second cache control unit 401. The first cache control unit 301 searches the memory unit 32 and checks the cache tag CT of the target entry E3t.

It is assumed that the target entry E3t is the third entry of the memory unit 32 illustrated in FIG. 5 and the target logical address LAt is X1. No data is stored in the cache line CL of the third entry (Empty). This is a case where there is no data in the target entry E3t of the memory unit 32 and the write request WR, the target logical address LAt, and the write data WD are transmitted to the second cache 24. In this case, the first cache control unit 301 maintains the third entry.

It is assumed that the target entry E3t is the second entry of the memory unit 32 illustrated in FIG. 5 and the target logical address LAt is X2=0x00000101. The data of the target logical address LAt is stored (Valid) in the cache line CL of the second entry, and “1” is not stored in the field F2 of the second entry. This is a case where the data of the target logical address LAt exists in the target entry E3t of the memory unit 32 and is in the Valid state, the data is cleared, and the write request WR, the target logical address LAt, and the write data WD are transmitted to the second cache 24. In this case, the first cache control unit 301 clears the cache line CL, stores “E” in the field F1, and clears the field F2 in the second entry. The state transition of the cache tag CT of the target entry E3t corresponds to the transition of (1) of FIG. 8.

It is assumed that the target entry E3t is the first entry of the memory unit 32 illustrated in FIG. 5 and the target logical address LAt is X3=0x00000000. The data of the target logical address LAt is stored (Lock) in the cache line CL of the first entry, and “1” is stored in the field F2 of the first entry. This is a case where the data of the target logical address LAt exists in the target entry E3t of the memory unit 32 and is in the Lock state, the data is cleared, and the write request WR, the target logical address LAt, and the write data WD are transmitted to the second cache 24. In this case, the first cache control unit 301 clears the cache line CL, stores “E” in the field F1, and clears the field F2 in the first entry. The state transition of the cache tag CT of the target entry E3t corresponds to the transition in (6) of FIG. 8.

After writing is performed based on the write request WR from the host 2, the write data WD is evicted from the cache in the host 2. That is, this state is a state in which the host 2 determines that the data is unnecessary data. Therefore, it is considered that the read request RR for the data from the host 2 to the first cache 23 will not come for a while. Therefore, the cache tag CT of the first entry transitions as (6) in FIG. 8.

It is assumed that the target entry E3t is the second entry of the memory unit 32 illustrated in FIG. 5 and the target logical address LAt is X4=0x00000001. Data of a logical address different from the target logical address LAt is stored (Valid) in the cache line CL of the second entry, and “1” is not stored in the field F2 of the second entry. This is a case where data of another logical address LA exists in the target entry E3t of the memory unit 32 and is in the Valid state, and the write request WR, the target logical address LAt, and the write data WD are transmitted to the second cache 24. In this case, the first cache control unit 301 maintains the second entry.

It is assumed that the target entry E3t is the first entry of the memory unit 32 illustrated in FIG. 5 and the target logical address LAt is X5=0x00000100. Data of a logical address different from the target logical address LAt is stored (Lock) in the cache line CL of the first entry, and “1” is stored in the field F2 of the first entry. This is a case where data of another logical address LA exists in the target entry E3t of the memory unit 32 and is in the Lock state, and the write request WR, the target logical address LAt, and the write data WD are transmitted to the second cache 24. In this case, the first cache control unit 301 maintains the first entry.

### 1.3 Effects According to Present Embodiment

In the memory system including the nonvolatile memory and the memory controller, upon receiving the read request from the host, in a case where prefetch data is stored in the cache in the memory controller, the memory controller transmits the prefetch data stored in the cache to the host.

However, in a case where data eviction occurs in the cache and prefetch data is evicted from the cache, the prefetch data may not be stored in the cache in a case where the memory controller receives the read request from the host. In this case, the memory controller reads data from the nonvolatile memory again, and transmits the read data to the host. Therefore, the data reading performance is deteriorated as compared with the case where the prefetch data is stored in the cache.

Therefore, the memory system 3 according to the present embodiment includes the nonvolatile memory 10 and the memory controller 20. The memory controller 20 includes the prefetch controller 201, the first cache 23 including the first memory unit 32 and the first cache control unit 301, the second cache 24 including the second memory unit 42 and the second cache control unit 401, and the NAND controller 202. That is, the memory system 3 includes three layers of the first cache 23, the second cache 24, and the nonvolatile memory 10. The first cache 23 is connectable to the host. The second cache 24 is connected to the first cache 23. The memory unit 32 of the first cache 23 includes the Lock flag field F2 in the cache tag CT. The field F2 stores the prefetch data PD in the Lock state and stores the read data RD in the Unlock state.

The prefetch controller 201 controls the prefetch process based on the submission queue SQ stored in the memory in the host 2. Specifically, upon detecting that the prefetch request PR is entered in the submission queue SQ, the prefetch controller 201 transmits the prefetch request PR and the target logical address LAt to the first cache control unit 301.

Upon receiving the prefetch request PR and the target logical address LAt from the prefetch controller 201, the first cache control unit 301 stores the prefetched data of the target logical address LA in the memory unit 32 in the Lock state as the prefetch data PD. The first cache control unit 301 maintains the prefetch data PD stored in the memory unit 32 until receiving the read request RR or the write request WR for the target logical address LAt from the host 2. In addition, the first cache control unit 301 does not perform an eviction control of the prefetch data PD stored in the Lock state from the memory unit 32 by the read data RD of another target logical address LAt. Therefore, the probability of cache miss of the prefetch data PD can be significantly reduced as compared with the case where the prefetch data PD is not stored in the memory unit 32 by the above method. Furthermore, the memory unit 32 includes, for example, an SRAM as a memory element. Therefore, the latency at the time of cache hit can be improved as compared with a memory element other than the SRAM. As described above, according to the present embodiment, data reading performance can be improved.

In addition, upon receiving a read request or a write request for the prefetch data PD stored in the memory unit 32 in the Lock state from the host 2, the first cache control unit 301 clears the prefetch data PD of the memory unit 32 and sets the entry of the corresponding index to the Empty state (transition of (6) in FIG. 8). On the other hand, upon receiving the read request from the host 2, the first cache control unit 301 can store the read data RD in the memory unit 32 in a case where the entry of the corresponding index in the memory unit 32 is in the Empty state (transition of (2) in FIG. 8). Therefore, according to the present embodiment, the use efficiency of the cache can be improved.

Further, the memory controller 20 includes the second cache 24 capable of storing the read data RD and the write data WD. In a case where the prefetch data PD is evicted from the first cache 23 by another prefetch data PD, the data can be stored in the second cache 24 as the read data RD. In a case where the prefetch data PD is evicted from the first cache 23 by the write data WD for the same data, the data can be stored in the second cache 24 as the write data WD. In such a situation, the read request RR for the prefetch data PD from the host 2 can be read from the second cache 24 and responded. Therefore, according to the present embodiment, the probability of a cache miss can be reduced as compared with a case where the memory controller 20 does not include the second cache 24.

### 1.4 First Modification

A memory system according to a first modification of the first embodiment will be described. In the memory system 3 according to the first modification of the first embodiment, a functional configuration of the prefetch controller 201 is different from that of the first embodiment. In the following description, points different from the first embodiment will be mainly described.

### 1.4.1 Functional Configuration of Memory Controller

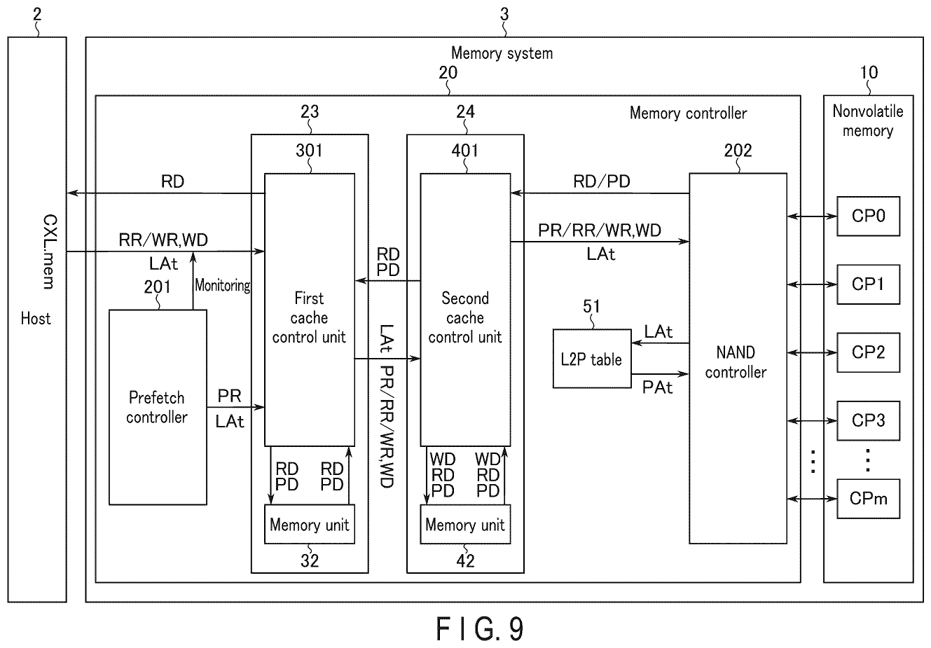

A functional configuration of a memory controller 20 will be described with reference to FIG. 9. FIG. 9 is a block diagram illustrating an example of a functional configuration of the memory controller 20.

### (Prefetch Controller 201)

The prefetch controller 201 creates an access sequence AS by learning in advance an access pattern from the host 2 to the memory system 3 using a CXL.mem protocol. The prefetch controller 201 monitors access from the host 2 to the first cache control unit 301 using the CXL.mem protocol. Upon detecting the logical address LA that triggers the learned access pattern in the access, the prefetch controller 201 transmits the prefetch request PR and the target logical address LAt to the first cache control unit 301. That is, in the present embodiment, the prefetch request PR is transmitted to the first cache control unit 301 by the prefetch controller 201. At this time, the prefetch controller 201 replays the access sequence AS created in advance. By this, the prefetch process is performed.

In the memory controller 20, the functional configuration other than the prefetch controller 201 is similar to the functional configuration of FIG. 7 illustrated in the first embodiment.

### 1.4.2 Effects According to Present Modification

According to the present modification, effects similar to those of the first embodiment are obtained. In addition, according to the present modification, the memory system 3 can autonomously control the prefetch process.

### 1.5 Second Modification

A memory system according to a second modification of the first embodiment will be described. The memory system 3 according to the second modification of the first embodiment is different from that of the first embodiment in that the prefetch controller 201 is omitted from the memory controller 20. In the memory system 3 according to the second modification of the first embodiment, the functional configuration of the first cache control unit 301 is different from that of the first embodiment. In the following description, points different from the first embodiment will be mainly described.

### 1.5.1 Functional Configuration of Memory Controller

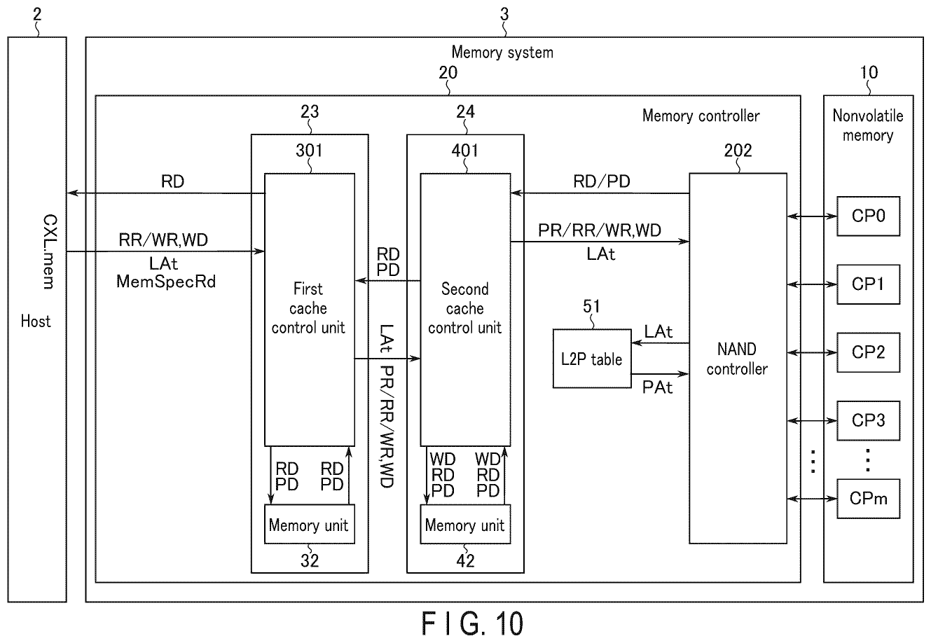

A functional configuration of the memory controller 20 will be described with reference to FIG. 10. FIG. 10 is a block diagram illustrating an example of a functional configuration of the memory controller 20.

### (First Cache Control Unit 301)

The host 2 transmits a Memory Speculative Read command (MemSpecRd) by using a CXL.mem protocol. The MemSpecRd is a speculative read command (command to transfer data to a cache) that does not respond to the host 2, and is defined in the CXL standard. Upon receiving the MemSpecRd and the target logical address LAt from the host 2 using a CXL.mem protocol, the first cache control unit 301 transmits the prefetch request PR and the target logical address LAt to the second cache control unit 401. The MemSpecRd corresponds to the prefetch request PR. That is, in the present embodiment, the prefetch request PR is transmitted to the first cache control unit 301 by the host 2. By this, the prefetch process is performed.

In the memory controller 20, the functional configuration other than the first cache control unit 301 is similar to the functional configuration of FIG. 7 illustrated in the first embodiment.

### 1.5.2 Effects According to Present Modification

According to the present modification, effects similar to those of the first embodiment are obtained. In addition, according to the present modification, the host 2 can directly control the prefetch process.

### 2. Second Embodiment

A memory system according to a second embodiment will be described. In the memory system 3 according to the second embodiment, a hardware configuration and a functional configuration of the first cache 23 and a configuration of the memory unit 32 of the first cache 23 are different from those of the first embodiment. In the following description, points different from the first embodiment will be mainly described.

### 2.1 Hardware Configuration of Memory Controller

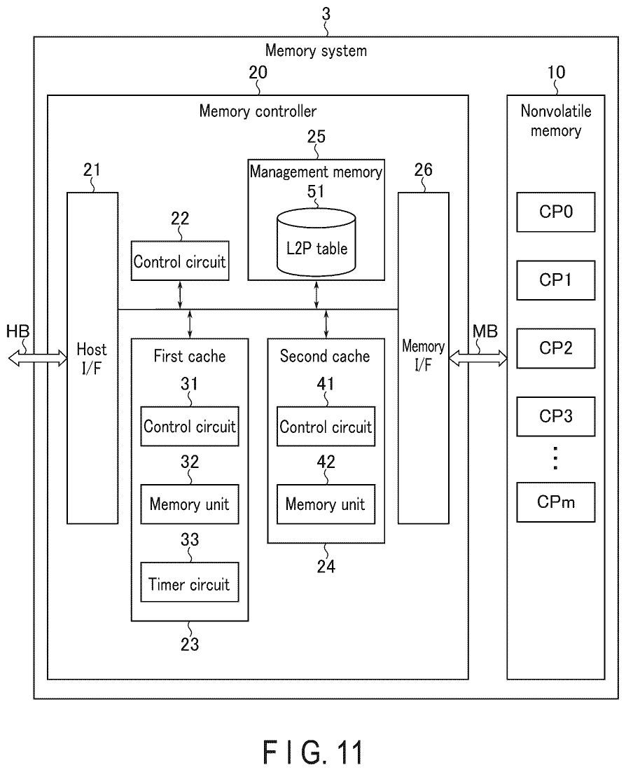

A hardware configuration of the memory controller 20 will be described with reference to FIG. 11. FIG. 11 is a block diagram illustrating an example of the hardware configuration of the memory controller 20. As illustrated in FIG. 11, the first cache 23 includes the control circuit 31, the memory unit 32, and a timer circuit 33.

The timer circuit 33 is a circuit that acquires the current time and measures an elapsed time T1 from a time at which prefetch data PD is stored in the memory unit 32 to the current time. Hereinafter, the function of measuring the elapsed time T1 is referred to as a “watch dog timer (WDT) function”.

In the memory controller 20, the hardware configuration other than the timer circuit 33 is similar to the hardware configuration of FIG. 3 illustrated in the first embodiment.

### 2.2 Configuration of Memory Unit of First Cache

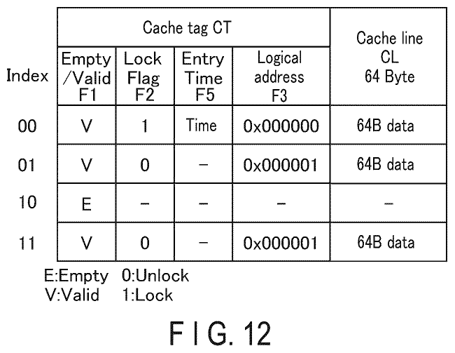

The configuration of the memory unit 32 of the first cache 23 will be described with reference to FIG. 12. FIG. 12 is a diagram illustrating an example of a configuration of the memory unit 32. As illustrated in FIG. 12, the cache tag CT includes the E/V field F1, the Lock flag field F2, an entry time field F5, and the logical address field F3.

The entry time field F5 is a field for storing the time at which the data is stored in the cache line CL in the Lock state (entry time ET), that is, the time at which “1” is stored in the Lock flag field F2. In a case where there is no data in the cache line CL (Empty) and in a case where data is stored in the cache line CL in the Unlock state (Valid), the entry time field F5 is in a state in which the value thereof is not set (−). In a case where the data is stored in the cache line CL in the Lock state (Lock), the entry time ET (for example, yyyy/mm/dd hh:mm:ss) is stored in the entry time field F5. Note that a format of the entry time ET may be any format that the controller can manage time, and is not limited thereto.

In the memory unit 32, the configuration of the check tag CT other than the entry time field F5 and the configuration of the cache line CL are similar to the configuration of FIG. 5 illustrated in the first embodiment. The method of allocating the plurality of logical addresses LA to entries included in the memory unit 32 is similar to that of the first embodiment.

### 2.3 Functional Configuration of Memory Controller

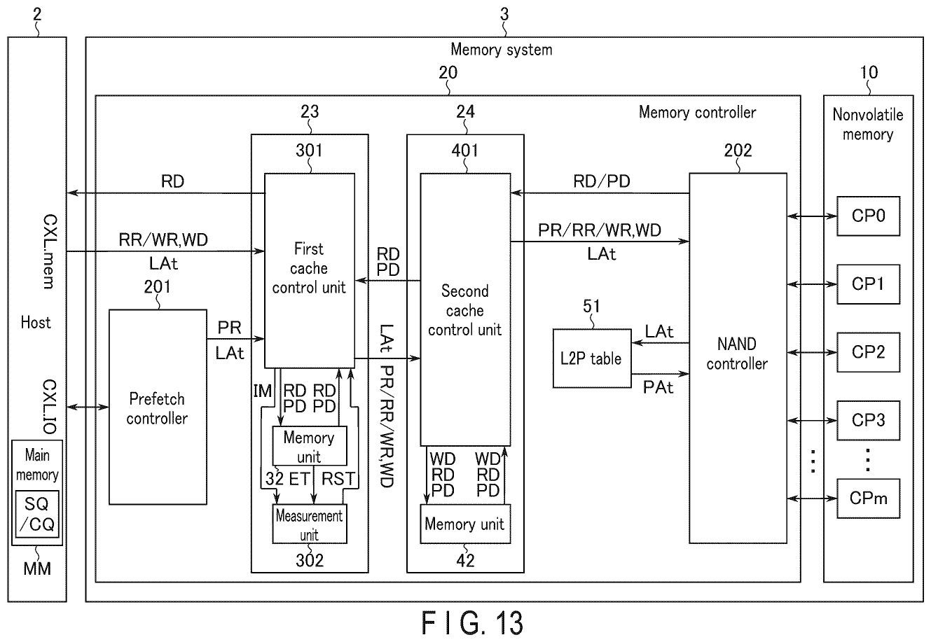

A functional configuration of the memory controller 20 will be described with reference to FIG. 13. FIG. 13 is a block diagram illustrating an example of the functional configuration of the memory controller 20. As illustrated in FIG. 13, the memory controller 20 includes the prefetch controller 201 and the NAND controller 202 as functional blocks. The first cache 23 includes the first cache control unit 301 and a measurement unit 302 as functional blocks. The second cache 24 includes the second cache control unit 401 as a functional block. The timer circuit 33 of the first cache 23 functions as the measurement unit 302.

### (First Cache Control Unit 301)

In a case of storing the prefetch data PD in the target entry E3t in the Lock state, the first cache control unit 301 also stores the entry time ET at which the prefetch data PD is stored in the target entry E3t.

For example, upon receiving the read request RR and the target logical address LAt from the host 2 using the CXL.mem protocol, the first cache control unit 301 searches the memory unit 32 based on the target logical address LAt.

In a case where data of another logical address LA is stored in the target entry E3t (the target entry E3t is in the Valid state or the Lock state), the first cache control unit 301 reads the read data RD and transmits the read data RD to the host 2, similarly to the first embodiment. In a case where the data of the target entry E3t is in the Lock state (the target entry E3t is in the Lock state), the first cache control unit 301 performs a WDT determination process. The WDT determination process is as follows.

The first cache control unit 301 transmits an instruction IM for measuring the elapsed time T1 to the measurement unit 302. The first cache control unit 301 receives the measurement result RST of the elapsed time T1 from the measurement unit 302. In a case where the measurement result RST (elapsed time T1) exceeds a predetermined constant time TT, the first cache control unit 301 updates the data of the target entry E3t to the Unlock state and clears the entry time ET of the target entry E3t. In a case where the measurement result RST is less than the constant time TT, the first cache control unit 301 maintains the target entry E3t.

The functional configuration of the first cache control unit 301 other than the above is similar to that of the first embodiment.

### (Measurement Unit 302)

The measurement unit 302 has a WDT function. The measurement unit 302 receives the instruction IM to measure the elapsed time T1 from the first cache control unit 301. The measurement unit 302 measures the elapsed time T1 from the time at which “1” is stored in the field F2 of the target entry E3t to the current time based on the instruction IM. The measurement unit 302 transmits the measurement result RST to the first cache control unit 301.

In the memory controller 20, the functional configuration other than the first cache control unit 301 and the measurement unit 302 is similar to the functional configuration of FIG. 7 illustrated in the first embodiment.

### 2.4 Operation of First Cache

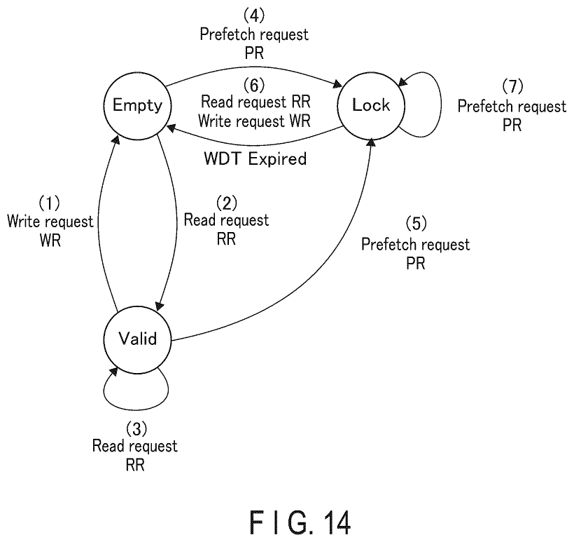

The operation of the first cache 23 will be described with reference to FIGS. 12 and 14. FIG. 14 is a diagram illustrating an example of a state transition of the cache tag CT of the target entry E3t of the memory unit 32.

For example, upon receiving the read request RR and the target logical address LAt from the host 2, the first cache control unit 301 of the first cache 23 searches the memory unit 32 and checks the cache tag CT of the target entry E3t.

It is assumed that the target entry E3t is the first entry of the memory unit 32 illustrated in FIG. 12 and the target logical address LAt is X5=0x00000100. Data of a logical address different from the target logical address LAt is stored (Lock) in the cache line CL of the first entry, “1” is stored in the field F2 of the first entry, and the entry time ET is stored in the field F5 of the first entry. This is a case where the data of another logical address LA exists in the target entry E3t of the memory unit 32 and is in the Lock state, and the data of the target logical address LAt is received from the second cache 24 and transmitted to the host 2 as the read data RD. In this case, the first cache control unit 301 performs the WDT determination process. In the WDT determination process, in a case where the measurement result RST exceeds the constant time TT (in the case of WDT Expired), the first cache control unit 301 updates the value of the field F2 to “0”, and clears the field F5 in the first entry. The state transition of the cache tag CT of the target entry E3t corresponds to the transition of (6) of FIG. 14. In a case where the measurement result RST is less than the constant time TT, the first cache control unit 301 maintains the first entry.

### 2.5 Effects According to Present Embodiment

According to the second embodiment, the effects similar to those of the first embodiment are obtained.

In a case where the prefetch request PR is, for example, a speculative request as in the second modification of the first embodiment, the read request RR from the host 2 to the prefetch data PD is not necessarily issued. In this case, the prefetch data PD continues to be maintained in the Lock state, and a deadlock may occur.

Therefore, in the present embodiment, the first cache 23 further includes the measurement unit 302. The memory unit 32 of the first cache 23 further includes the entry time field F5 in the cache tag CT. The field F5 stores the entry time ET at which the prefetch data PD is stored in the Lock state.

For example, upon receiving the read request RR and the target logical address LAt from the host 2, the first cache control unit 301 performs the WDT determination process in a case where data of another logical address LA is stored in the target entry E3t in the Lock state. In the WDT determination process, the measurement unit 302 measures the elapsed time T1 from the entry time ET to the current time. In a case where the measurement result RST exceeds the constant time TT, the first cache control unit 301 updates the field F2 of the target entry Est to “0” and clears the field F5 of the target entry E3t. By this, according to the present embodiment, it is possible to avoid occurrence of a deadlock.

Of course, the first modification and the second modification of the first embodiment can also be applied to the present embodiment.

### 3. Third Embodiment

A memory system according to a third embodiment will be described. In the memory system 3 according to the third embodiment, the configuration of the memory unit 32 of the first cache 23 is different from that of the first embodiment. In the following description, points different from the first embodiment will be mainly described.

### 3.1 Configuration of Memory Unit of First Cache

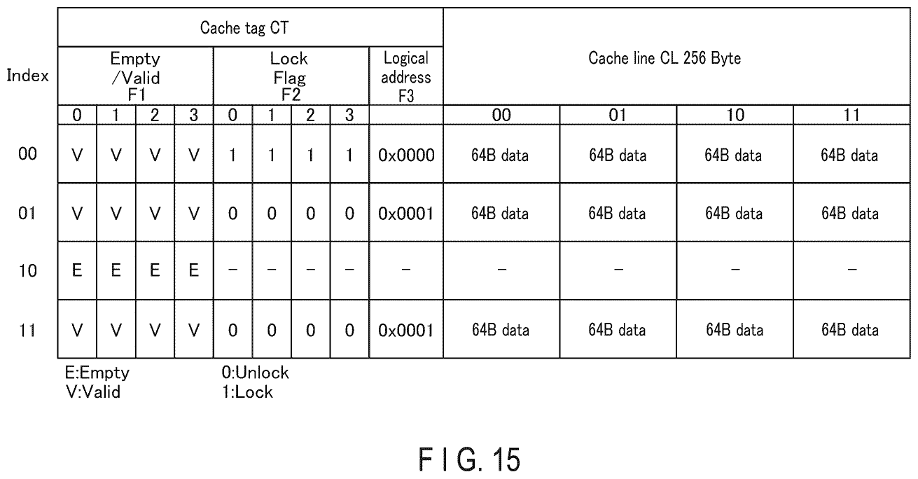

The configuration of the memory unit 32 of the first cache 23 will be described with reference to FIG. 15. FIG. 15 is a diagram illustrating an example of a configuration of the memory unit 32. As illustrated in FIG. 15, the line size of the cache line CL is, for example, 256B. That is, one cache line CL stores four pieces of 64B data. Each of the four pieces of 64B data corresponds to lower two bits (“00”, “01”, “10”, and “11”) of the logical address LA.

In the present embodiment, for example, a plurality of logical addresses LA is grouped by upper two bits (“00”, “01”, “10”, and “11”) among lower four bits of each of the logical addresses LA, and each group is allocated to one entry of the memory unit 32. That is, the memory unit 32 includes four entries. Each entry manages the upper two bits of the lower four bits of the logical address LA as an index number.

The E/V field F1 is similar to the memory unit 32 of FIG. 5 illustrated in the first embodiment except that the E/V field F1 includes four subfields 0 to 3. The four subfields 0 to 3 correspond to the lower two bits of the logical address LA, respectively.

The Lock flag field F2 is similar to the memory unit 32 in FIG. 5 illustrated in the first embodiment except that the Lock flag field F2 includes four subfields 0 to 3. The four subfields 0 to 3 correspond to the lower two bits of the logical address LA, respectively.

The logical address field F3 is similar to the memory unit 32 of FIG. 5 illustrated in the first embodiment. In the example of FIG. 15, upper bits ((K−4) bits) of the logical address LA except lower four bits are stored in the logical address field F3.

In the example of FIG. 15, in the entry having the tag information of the index “00”, four pieces of 64B data are stored (Lock) in the cache line CL, “V” is stored in each of the subfields 0 to 3 of the E/V field F1, “1” is stored in each of the subfields 0 to 3 of the Lock flag field F2, and “0x0000” is stored in the logical address field F3. That is, the prefetch data PD is stored in the entry to which the address values “0x00000000” to “0x00000011” (=logical address LA) obtained by concatenating the address value of the logical address field F3, the index number, and the lower two bits of the logical address LA are allocated.

In the entry having the tag information of the index “01”, four pieces of 64B data are stored (Valid) in the cache line CL, “V” is stored in each of the subfields 0 to 3 of the E/V field F1, “0” is stored in each of the subfields 0 to 3 of the Lock flag field F2, and “0x0001” is stored in the logical address field F3. That is, the read data RD is stored in the entry to which the address values “0x00010100” to “0x00010111” (=logical address LA) obtained by concatenating the address value of the logical address field F3, the index number, and the lower two bits of the logical address LA are allocated.

In the entry having the tag information of the index “10”, the cache line CL is in a state where the data is not set (−) (Empty), “E” is stored in each of the subfields 0 to 3 of the E/V field F1, and each of the subfields 0 to 3 of the Lock flag field F2 and the logical address field F3 are in a state where the values are not set (−). That is, no data is stored in the entry having the tag information of the index “10”.

In the entry having the tag information of the index “11”, four pieces of 64B data are stored (Valid) in the cache line CL, “V” is stored in each of the subfields 0 to 3 of the E/V field F1, “0” is stored in each of the subfields 0 to 3 of the Lock flag field F2, and “0x0001” is stored in the logical address field F3. That is, the read data RD is stored in the entry to which the address values “0x00011100” to “0x00011111” (=logical address LA) obtained by concatenating the address value of the logical address field F3, the index number, and the lower two bits of the logical address LA are allocated.

In the example of FIG. 15, as a method of allocating the plurality of logical addresses LA to the entries included in the memory unit 32, an allocation method by the direct map method (1-way set associative method) is illustrated, but an allocation method by the L-way set associative method (L is an integer of 2 or more) may be used. In addition, the number of index numbers is not limited to four, and may be increased to any number (a power of two).

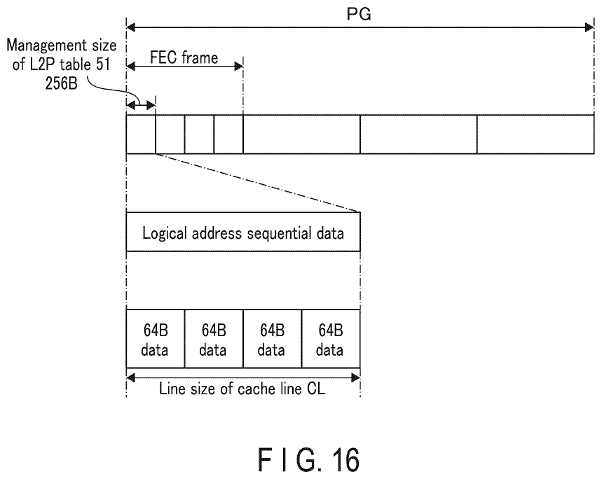

FIG. 16 is a diagram illustrating a relationship between the management size (L2P management size) of the L2P table and the size of the cache line CL of the memory unit 32 of the first cache 23. It is assumed that the L2P management size is 256B and the page PG of the NAND chip CP is 4 KB. In the page PG, data is stored in units of 256B. In a case where the page PG is divided into four forward error correction (FEC) frames in units of 1 KB, for example, four pieces of 256B data are included in one FEC frame. The FEC is a unit of error correction executed by an error correction circuit (not illustrated) in the memory controller 20.

In addition, in a case of writing data to the nonvolatile memory 10, data is written in units of 256B to the page PG of the selected NAND chip CP in the nonvolatile memory 10. In a case of reading data from the nonvolatile memory 10, data is read in units of 256B by one reading from the page PG of the selected NAND chip CP in the nonvolatile memory 10. The 256B data read by one reading includes four pieces of 64B data having sequential logical addresses LA. Therefore, in a case where the line size of the cache line CL of the memory unit 32 is set to the L2P management size (256B) or less, it is guaranteed that the size of the data stored in the cache line CL falls within one reading of 256B data.

In a case where the line size is 64B, 64B data of the target logical address LAt among 256B data read by one reading is stored in the cache line CL. In a case where the line size is 256B, 256B data (64B data of the target logical address LAt and 192 (=64×3) B data corresponding to three logical addresses LA sequential to the target logical address LAt) read by one reading is stored in the cache line CL.

In the present embodiment, the line size of the cache line CL of the memory unit 32 is the same as the L2P management size.

### 3.2 Functional Configuration of Memory Controller

A functional configuration of the memory controller 20 will be described. In the memory controller 20, the functional configuration other than the first cache control unit 301 is similar to the functional configuration of FIG. 7 illustrated in the first embodiment.

The first cache control unit 301 receives 256B data (64B data corresponding to the target logical address LAt and 192 (=64×3) B data corresponding to three logical addresses LA sequential to the target logical address LAt) read from the second cache 24 or the nonvolatile memory 10 from the second cache control unit 401, and stores the received 256B data in the target entry E3t in the Unlock state or the Lock state. That is, the first cache control unit 301 stores the received 256B data in the cache line CL, stores “V” in each of the subfields 0 to 3 of the field F1, and stores “0” or “1” in each of the subfields 0 to 3 of the field F2 in the target entry E3t.

In a case where the 64B data of the target logical address LAt stored in the target entry E3t is evicted, the first cache control unit 301 clears the 256B data of the cache line CL, stores “E” in each of the subfields 0 to 3 of the field F1, and clears each of the subfields 0 to 3 of the field F2 in the target entry E3t.

The functional configuration of the first cache control unit 301 other than the above is similar to that of the first embodiment.

### 3.3 Effects According to Present Embodiment

According to the third embodiment, the effects similar to those of the first embodiment are obtained.

In the present embodiment, the size of the cache line CL of the memory unit 32 of the first cache 23 is the same as the L2P management size. This makes it possible to store, in the cache line CL of the memory unit 32, the 64B data of the target logical address LAt and the 192B data corresponding to the three logical addresses LA sequential to the target logical address LAt, which are read out by reading 256B data once. In consideration of locality of data in a program executed by the host 2, it is considered that there is a relatively high possibility that data in which the target logical address LAt is close to the logical address LA is accessed from the host 2. Therefore, according to the present embodiment, since the amount of data that can be stored in one cache line CL and the amount of data read from the nonvolatile memory 10 at a time coincide with each other, it is efficient in that reading from the nonvolatile memory 10 can be performed without excess or deficiency. In addition, since the capacity of the cache is larger than that in a case where the line size is smaller than 256B, the probability of a cache miss can be reduced.

Of course, the second embodiment and the first modification and the second modification of the first embodiment can also be applied to the present embodiment. In a case where the second embodiment is applied to the present embodiment, in the cache tag CT, the entry time field F5 may be included as many as the number of subfields, or only one entry time field F5 may be included as a representative. In a case where one entry time field F5 is included in the cache tag CT, the time at which the prefetch data PD of the last logical address LA among the sequential logical addresses LA is stored is stored in the field F5.

### 4. Fourth Embodiment

A memory system according to a fourth embodiment will be described. In the memory system 3 according to the fourth embodiment, the operations of the first cache 23 and the second cache 24 are partially different from those of the first embodiment. In the following description, points different from the first embodiment will be mainly described.

In the present embodiment, the memory unit 42 of the second cache 24 does not have a copy of data stored in the memory unit 32 of the first cache 23. The operations of the first cache 23 and the second cache 24 are as follows.

### 4.1 Operation of First Cache and Second Cache

### (Operation in Response to Prefetch Request PR)

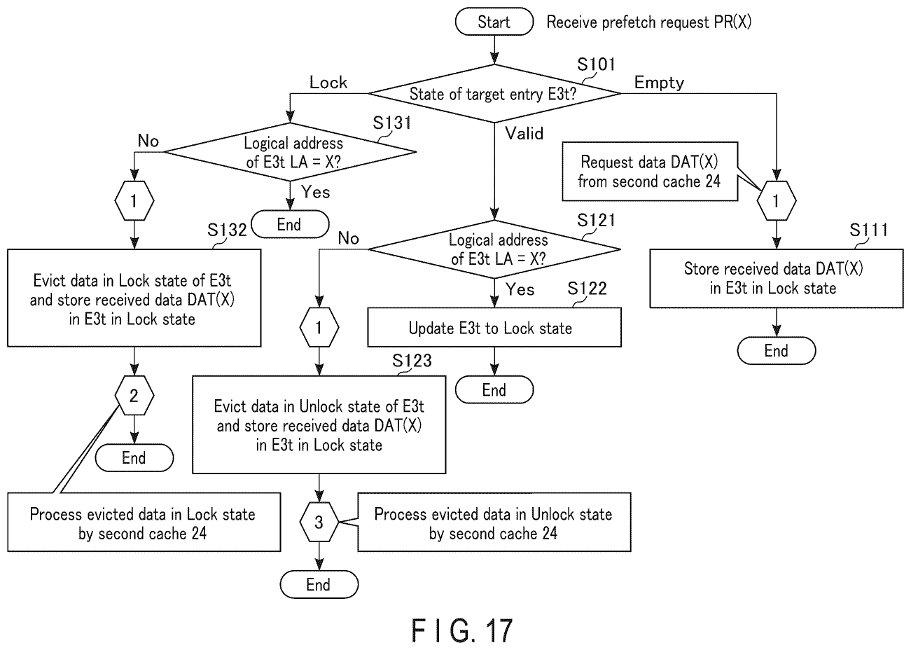

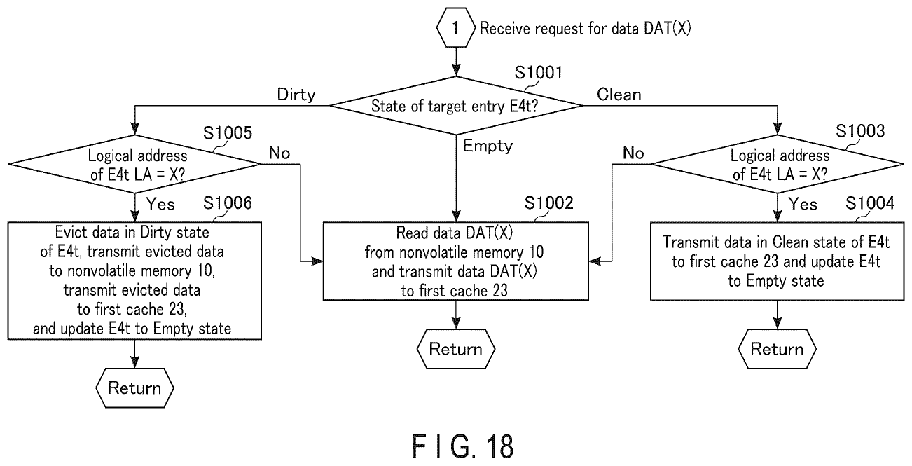

An operation in response to the prefetch request PR will be described with reference to FIGS. 17 to 20. FIG. 17 is a flowchart illustrating an example of the operation of the first cache 23. FIGS. 18 to 20 are flowcharts illustrating an example of the operation of the second cache 24.

Here, a case where there is the prefetch request PR for data of the target logical address LAt=X will be described as an example. Hereinafter, the prefetch request PR for the data of the target logical address LAt=X is referred to as a “prefetch request PR(X)”. The data of the target logical address LAt=X is expressed as “data DAT(X)”.

As illustrated in FIG. 17, upon receiving the prefetch request PR(X) from the prefetch controller 201, the first cache control unit 301 of the first cache 23 searches the memory unit 32 and checks the cache tag CT of the target entry E3t (S101).

In a case where the target entry E3t is in the Empty state (S101 Empty), the first cache control unit 301 requests the data DAT(X) from the second cache 24. Specifically, the first cache control unit 301 causes a second cache control unit 401 to execute a process 1 (a process of reading the data DAT(X)), and receives the data DAT(X) from the second cache control unit 401. Details of the process 1 will be described later. After the execution of the process 1, the first cache control unit 301 stores the received data DAT(X) in the target entry E3t in the Lock state (S111).

In a case where the target entry E3t is in the Valid state (S101 Valid), the first cache control unit 301 determines whether or not the logical address LA of the target entry E3t is X (S121).

In a case where the logical address LA of the target entry E3t is X (S121 Yes), the first cache control unit 301 updates the target entry E3t to the Lock state (S122).

In a case where the logical address LA of the target entry E3t is not X (S121 No), the first cache control unit 301 causes the second cache control unit 401 to execute the process 1 and receives the data DAT(X) from the second cache control unit 401. After the execution of the process 1, the first cache control unit 301 evicts the data in the Unlock state of the target entry E3t and stores the received data DAT(X) in the target entry E3t in the Lock state (S123). After the execution of step S123, the first cache control unit 301 causes the second cache control unit 401 to execute a process 3 (a process of the evicted data in the Unlock state in the second cache 24). Details of the process 3 will be described later.

In a case where the target entry E3t is in the Lock state (S101 Lock), the first cache control unit 301 determines whether or not the logical address LA of the target entry E3t is X (S131).

In a case where the logical address LA of the target entry E3t is X (S131 Yes), the first cache control unit 301 ends the process.

In a case where the logical address LA of the target entry E3t is not X (S131 No), the first cache control unit 301 causes the second cache control unit 401 to execute the process 1 and receives the data DAT(X) from the second cache control unit 401. After the execution of the process 1, the first cache control unit 301 evicts the data in the Lock state of the target entry E3t and stores the received data DAT(X) in the target entry E3t in the Lock state (S132). After the execution of step S132, the first cache control unit 301 causes the second cache control unit 401 to execute a process 2 (a process of the evicted data in the Lock state in the second cache 24). Details of the process 2 will be described later. Note that the first cache control unit 301 may maintain the target entry E3t in the Lock state without evicting the data in the Lock state of the target entry E3t instead of step S132. That is, the first cache 23 may preferentially store the data in the previous Lock state.

### (Process 1)

The process 1 will be described. As illustrated in FIG. 18, upon receiving the request for the data DAT(X) from the first cache 23, the second cache control unit 401 of the second cache 24 searches the memory unit 42 and checks the cache tag CT of the target entry E4t (S1001).

In a case where the target entry E4t is in the Empty state (S1001_Empty), the second cache control unit 401 reads the data DAT(X) from the nonvolatile memory 10 through the NAND controller 202 and transmits the read data DAT(X) to the first cache 23 (S1002). The target entry E4t after the execution of step S1002 is in the Empty state.

In a case where the target entry E4t is in the Clean state (S1001 Clean), the second cache control unit 401 determines whether or not the logical address LA of the target entry E4t is X (S1003).

In a case where the logical address LA of the target entry E4t is X (S1003 Yes), the second cache control unit 401 transmits the data in the Clean state of the target entry E4t to the first cache 23 and updates the target entry E4t to the Empty state (S1004).

In a case where the logical address LA of the target entry E4t is not X (S1003 No), the second cache control unit 401 executes step S1002. In the target entry E4t after the execution of step S1002, data of the logical address LA (X) is maintained in the Clean state.

In a case where the target entry E4t is in the Dirty state (S1001 Dirty), the second cache control unit 401 determines whether or not the logical address LA of the target entry E4t is X (S1005).

In a case where the logical address LA of the target entry E4t is X (S1005 Yes), the second cache control unit 401 evicts the data in the Dirty state of the target entry E4t and transmits the data to the nonvolatile memory 10 through the NAND controller 202. By this, the data in the Dirty state is written to the nonvolatile memory 10. Then, the second cache control unit 401 transmits the data in the Dirty state of the target entry E4t to the first cache 23 and updates the target entry E4t to the Empty state (S1006).

In a case where the logical address LA of the target entry E4t is not X (S1005 No), the second cache control unit 401 executes step S1002. In the target entry E4t after the execution of step S1002, the data of the logical address LA (X) is maintained in the Dirty state.

### (Process 2)

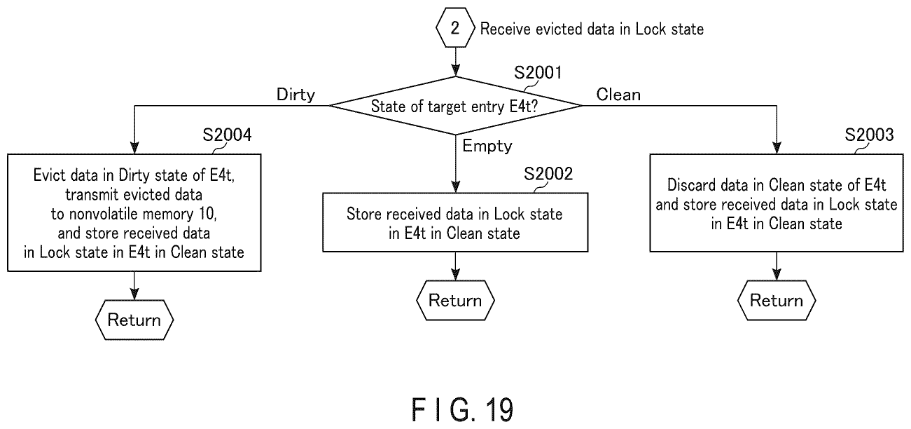

The process 2 will be described. As illustrated in FIG. 19, upon receiving the data in the Lock state evicted from the first cache 23, the second cache control unit 401 of the second cache 24 searches the memory unit 42 and checks the cache tag CT of the target entry E4t (S2001).

In a case where the target entry E4t is in the Empty state (S2001 Empty), the second cache control unit 401 stores the received data in the Lock state in the target entry E4t in the Clean state (S2002).

In a case where the target entry E4t is in the Clean state (S2001 Clean), the second cache control unit 401 discards the data in the Clean state of the target entry E4t, and stores the received data in the Lock state in the target entry E4t in the Clean state (S2003). That is, the second cache 24 preferentially stores the data in the Lock state.

In a case where the target entry E4t is in the Dirty state (S2001 Dirty), the second cache control unit 401 evicts data in the Dirty state of the target entry E4t and transmits the data to the nonvolatile memory 10 through the NAND controller 202. By this, the data in the Dirty state is written to the nonvolatile memory 10. Then, the second cache control unit 401 stores the received data in the Lock state in the target entry E4t in the Clean state (S2004). That is, the second cache 24 preferentially stores the data in the Lock state. Note that, in a case where the amount of writing to the nonvolatile memory 10 is reduced, the second cache control unit 401 may maintain the target entry E4t in the Dirty state without evicting the data in the Dirty state of the target entry E4t instead of step S2004, and discard the received data in the Lock state. That is, the second cache 24 may preferentially store the data in the Dirty state.

### (Process 3)

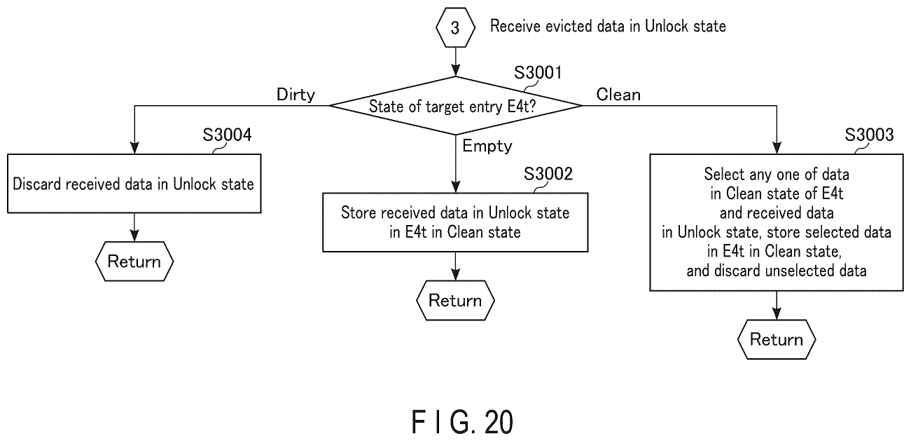

The process 3 will be described. As illustrated in FIG. 20, upon receiving the data in the Unlock state evicted from the first cache 23, the second cache control unit 401 of the second cache 24 searches the memory unit 42 and checks the cache tag CT of the target entry E4t (S3001).

In a case where the target entry E4t is in the Empty state (S3001 Empty), the second cache control unit 401 stores the received data in the Unlock state in the target entry E4t in the Clean state (S3002).

In a case where the target entry E4t is in the Clean state (S3001 Clean), the second cache control unit 401 selects either the data in the Clean state of the target entry E4t or the received data in the Unlock state, stores the selected data in the target entry E4t in the Clean state, and discards the unselected data (S3003).

In a case where the target entry E4t is in the Dirty state (S3001_Dirty), the second cache control unit 401 discards the received data in the Unlock state (S3004). That is, the second cache 24 preferentially stores the data in the Dirty state. In the target entry E4t after the execution of step S3004, the data of the logical address LA (≠X) is maintained in the Dirty state.

### (Operation in Response to Read Request RR)

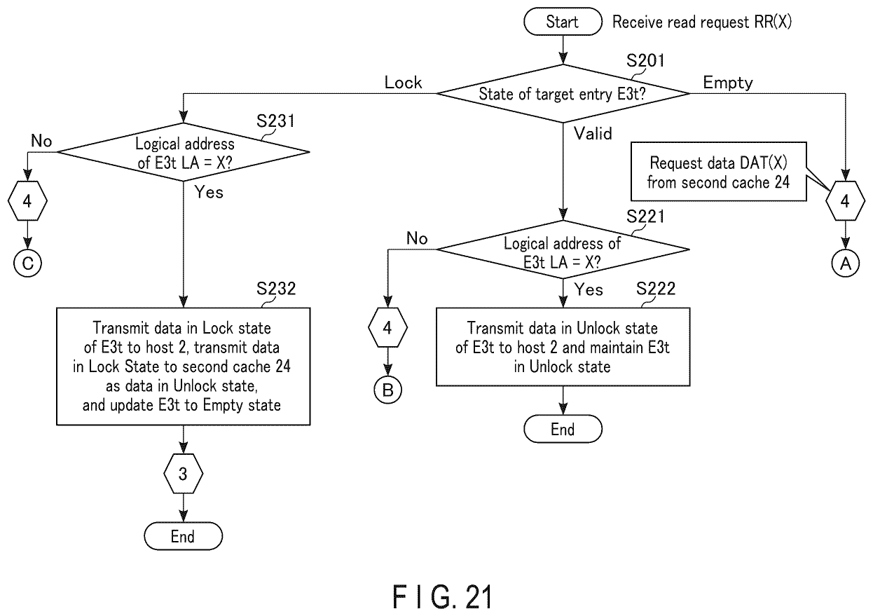

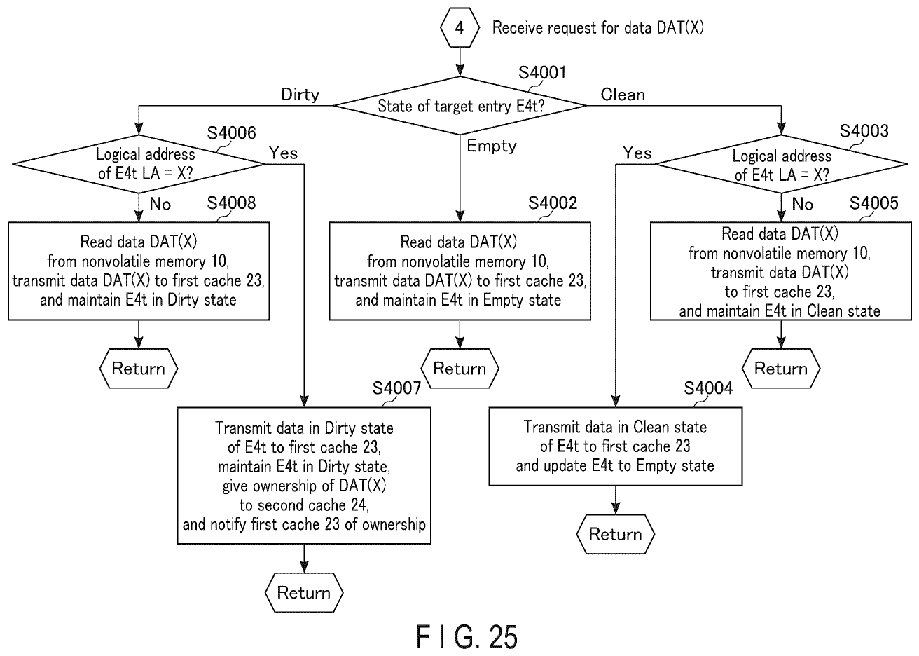

The operation in response to the read request RR will be described with reference to FIGS. 21 to 25. FIGS. 21 to 24 are flowcharts illustrating an example of the operation of the first cache 23. FIG. 25 is a flowchart illustrating an example of the operation of the second cache 24.

Here, a case where there is the read request RR for the data of the target logical address LAt=X will be described as an example. Hereinafter, the read request RR for the target logical address LAt=X is referred to as a “read request RR(X)”.

As illustrated in FIG. 21, upon receiving the read request RR(X) from the host 2, the first cache control unit 301 of the first cache 23 searches the memory unit 32 and checks the cache tag CT of the target entry E3t (S201).

In a case where the target entry E3t is in the Empty state (S201_Empty), the first cache control unit 301 requests the data DAT(X) from the second cache 24. Specifically, the first cache control unit 301 causes the second cache control unit 401 to execute a process 4 (a process of reading the data DAT(X)), and receives the data DAT(X) from the second cache control unit 401. Details of the process 4 will be described later.

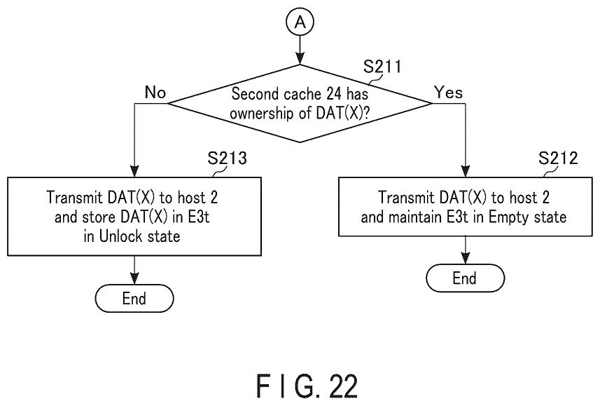

After execution of the process 4, as illustrated in FIG. 22, the first cache control unit 301 determines whether or not the second cache 24 has ownership of the data DAT(X) (S211).

In a case where the second cache 24 has the ownership of the data DAT(X) (S211 Yes), the first cache control unit 301 transmits the data DAT(X) to the host 2 and maintains the target entry E3t in the Empty state (S212).

In a case where the second cache 24 does not have the ownership of the data DAT(X) (S211 No), the first cache control unit 301 transmits the data DAT(X) to the host 2 and stores the data DAT(X) in the target entry E3t in the Unlock state (S213).

As illustrated in FIG. 21, in a case where the target entry E3t is in the Valid state (S201_Valid), the first cache control unit 301 determines whether or not the logical address LA of the target entry E3t is X (S221).

In a case where the logical address LA of the target entry E3t is X (S221_Yes), the first cache control unit 301 transmits the data in the Unlock state of the target entry E3t to the host 2 and maintains the target entry E3t in the Unlock state (S222).

In a case where the logical address LA of the target entry E3t is not X (S221_No), the first cache control unit 301 causes the second cache control unit 401 to execute the process 4 and receives the data DAT(X) from the second cache control unit 401.

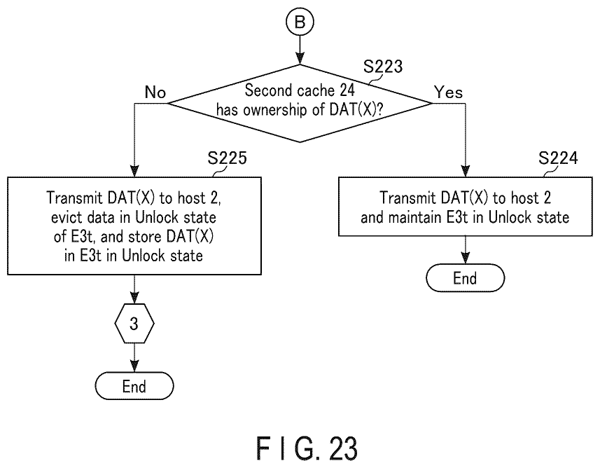

After execution of the process 4, as illustrated in FIG. 23, the first cache control unit 301 determines whether or not the second cache 24 has the ownership of the data DAT(X) (S223).

In a case where the second cache 24 has the ownership of the data DAT(X) (S223 Yes), the first cache control unit 301 transmits the data DAT(X) to the host 2 and maintains the target entry E3t in the Unlock state (S224).

In a case where the second cache 24 does not have the ownership of the data DAT(X) (S223 No), the first cache control unit 301 transmits the data DAT(X) to the host 2, evicts the data in the Unlock state of the target entry E3t, and stores the data DAT(X) in the target entry E3t in the Unlock state (S225). After the execution of step S225, the first cache control unit 301 causes the second cache control unit 401 to execute the above-described process 3.

As illustrated in FIG. 21, in a case where the target entry E3t is in the Lock state (S201_Lock), the first cache control unit 301 determines whether or not the logical address LA of the target entry E3t is X (S231).

In a case where the logical address LA of the target entry E3t is X (S231_Yes), the first cache control unit 301 transmits the data in the Lock state of the target entry E3t to the host 2 and transmits the data to the second cache 24 as data in the Unlock state, and updates the target entry E3t to the Empty state (S232). After the execution of step S232, the first cache control unit 301 causes the second cache control unit 401 to execute the above-described process 3.

In a case where the logical address LA of the target entry E3t is not X (S231_No), the first cache control unit 301 causes the second cache control unit 401 to execute the process 4 and receives the data DAT(X) from the second cache control unit 401.

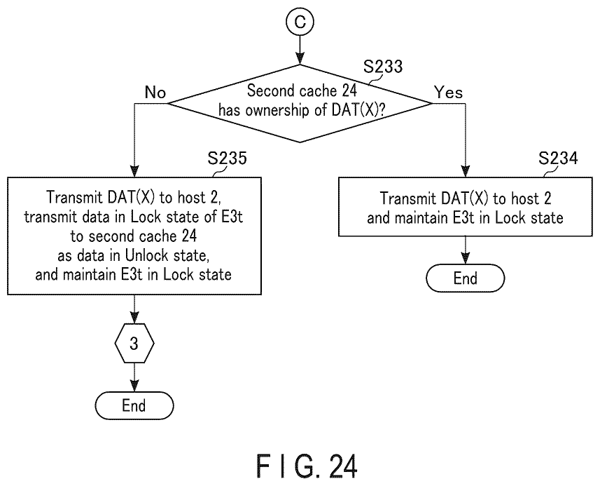

After execution of the process 4, as illustrated in FIG. 24, the first cache control unit 301 determines whether or not the second cache 24 has the ownership of the data DAT(X) (S233).

In a case where the second cache 24 has the ownership of the data DAT(X) (S233 Yes), the first cache control unit 301 transmits the data DAT(X) to the host 2 and maintains the target entry E3t in the Lock state (S234).

In a case where the second cache 24 does not have the ownership of the data DAT(X) (S233_No), the first cache control unit 301 transmits the data DAT(X) to the host 2, transmits the data in the Lock state of the target entry E3t to the second cache 24 as data in the Unlock state, and maintains the target entry E3t in the Lock state (S235). After the execution of step S235, the first cache control unit 301 causes the second cache control unit 401 to execute the above-described process 3.

### (Process 4)

The process 4 will be described. As illustrated in FIG. 25, upon receiving the request for the data DAT(X) from the first cache 23, the second cache control unit 401 of the second cache 24 searches the memory unit 42 and checks the cache tag CT of the target entry E4t (S4001).

In a case where the target entry E4t is in the Empty state (S4001 Empty), the second cache control unit 401 reads the data DAT(X) from the nonvolatile memory 10 through the NAND controller 202, transmits the read data DAT(X) to the first cache 23, and maintains the target entry E4t in the Empty state (S4002).

In a case where the target entry E4t is in the Clean state (S4001 Clean), the second cache control unit 401 determines whether or not the logical address LA of the target entry E4t is X (S4003).

In a case where the logical address LA of the target entry E4t is X (S4003 Yes), the second cache control unit 401 transmits the data in the Clean state of the target entry E4t to the first cache 23 and updates the target entry E4t to the Empty state (S4004). The target entry E4t is once set to the Empty state, but upon receiving the data DAT(X) from the first cache 23, the data of the target entry E4t is updated to the received data DAT(X) and the target entry E4t is updated to the Clean state. The process of moving the data DAT(X) like this may be omitted.

In a case where the logical address LA of the target entry E4t is not X (S4003 No), the second cache control unit 401 reads the data DAT(X) from the nonvolatile memory 10 through the NAND controller 202, transmits the read data DAT(X) to the first cache 23, and maintains the target entry E4t in the Clean state (S4005).

In a case where the target entry E4t is in the Dirty state (S4001 Dirty), the second cache control unit 401 determines whether or not the logical address LA of the target entry E4t is X (S4006).

In a case where the logical address LA of the target entry E4t is X (S4006 Yes), the second cache control unit 401 transmits the data in the Dirty state of the target entry E4t to the first cache 23 and maintains the target entry E4t in the Dirty state. That is, the second cache 24 preferentially stores the data in the Dirty state. Then, the second cache control unit 401 gives the ownership of the data DAT(X) to the second cache 24 and notifies the first cache 23 of the ownership (S4007). By this, a copy of the data DAT(X) is not created in the first cache 23.

In a case where the logical address LA of the target entry E4t is not X (S4006 No), the second cache control unit 401 reads the data DAT from the nonvolatile memory 10 through the NAND controller 202, transmits the read data DAT(X) to the first cache 23, and maintains the target entry E4t in the Dirty state (S4008).

### (Operation in Response to Write Request WR)

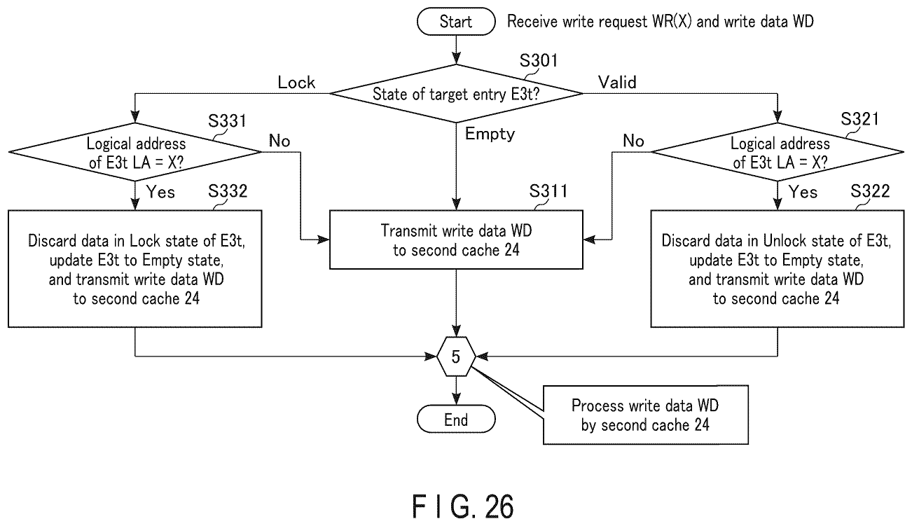

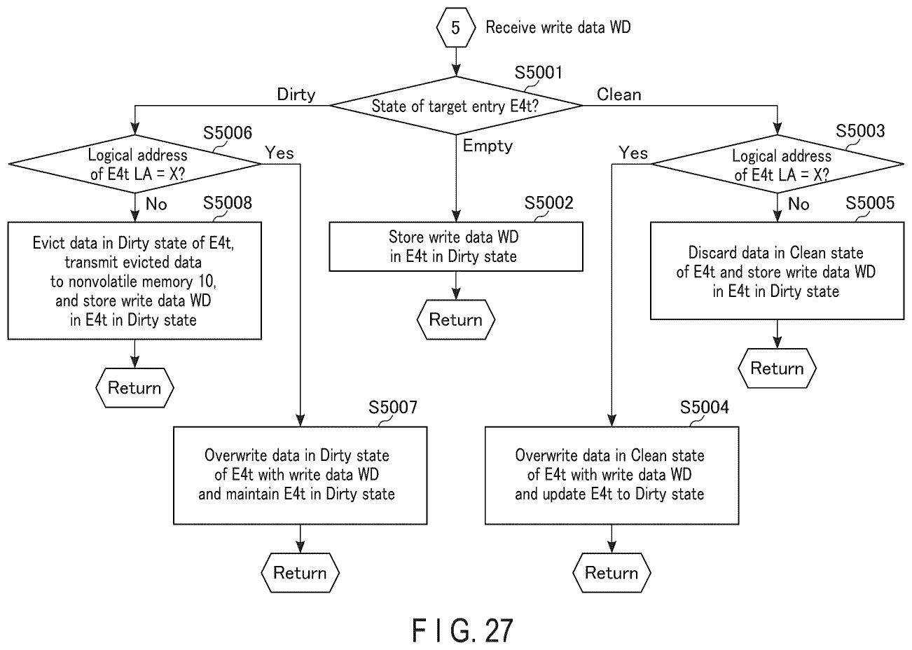

The operation in response to the write request WR will be described with reference to FIGS. 26 and 27. FIG. 26 is a flowchart illustrating an example of the operation of the first cache 23. FIG. 27 is a flowchart illustrating an example of the operation of the second cache 24.

Here, a case where there is a write request WR for the target logical address LAt=X will be described as an example. Hereinafter, the write request WR for the target logical address LAt=X is referred to as a “write request WR(X)”.

As illustrated in FIG. 26, upon receiving the write request WR(X) and the write data WD from the host 2, the first cache control unit 301 of the first cache 23 searches the memory unit 32 and checks the cache tag CT of the target entry E3t (S301).

In a case where the target entry E3t is in the Empty state (S301 Empty), the first cache control unit 301 transmits the write data WD to the second cache 24 (S311). The target entry E3t after the execution of step S311 is in the Empty state. After the execution of step S311, the first cache control unit 301 causes the second cache control unit 401 to execute a process 5 (a process of the write data WD in the second cache 24). Details of the process 5 will be described later.

In a case where the target entry E3t is in the Valid state (S301 Valid), the first cache control unit 301 determines whether or not the logical address LA of the target entry E3t is X (S321).

In a case where the logical address LA of the target entry E3t is X (S321 Yes), the first cache control unit 301 discards the data in the Unlock state of the target entry E3t, updates the target entry E3t to the Empty state, and transmits the write data WD to the second cache 24 (S322). After the execution of step S322, the first cache control unit 301 causes the second cache control unit 401 to execute the process 5.

In a case where the logical address LA of the target entry E3t is not X (S321 No), the first cache control unit 301 executes step S311. In the target entry E3t after the execution of step S311, the data of the logical address LA (X) is maintained in the Unlock state.

In a case where the target entry E3t is in the Lock state (S301_Lock), the first cache control unit 301 determines whether or not the logical address LA of the target entry E3t is X (S331).

In a case where the logical address LA of the target entry E3t is X (S331 Yes), the first cache control unit 301 discards the data in the Lock state of the target entry E3t, updates the target entry E3t to the Empty state, and transmits the write data WD to the second cache 24 (S332). After the execution of step S332, the first cache control unit 301 causes the second cache control unit 401 to execute the process 5.

In a case where the logical address LA of the target entry E3t is not X (S331 No), the first cache control unit 301 executes step S311. In the target entry E3t after the execution of step S311, the data of the logical address LA (X) is maintained in the Lock state.

### (Process 5)

The process 5 will be described. Upon receiving the write data WD from the first cache 23, the second cache control unit 401 of the second cache 24 searches the memory unit 42 and checks the cache tag CT of the target entry E4t (S5001).

In a case where the target entry E4t is in the Empty state (S5001_Empty), the second cache control unit 401 stores the write data WD in the target entry E4t in the Dirty state (S5002).

In a case where the target entry E4t is in the Clean state (S5001_Clean), the second cache control unit 401 determines whether or not the logical address LA of the target entry E4t is X (S5003).

In a case where the logical address LA of the target entry E4t is X (S5003_Yes), the second cache control unit 401 overwrites the data in the Clean state of the target entry E4t with the write data WD and updates the target entry E4t to the Dirty state (S5004).

In a case where the logical address LA of the target entry E4t is not X (S5003_No), the second cache control unit 401 discards the data in the Clean state of the target entry E4t and stores the write data WD in the target entry E4t in the Dirty state (S5005).

In a case where the target entry E4t is in the Dirty state (S5001_Dirty), the second cache control unit 401 determines whether or not the logical address LA of the target entry E4t is X (S5006).

In a case where the logical address LA of the target entry E4t is X (S5006_Yes), the second cache control unit 401 overwrites the data in the Dirty state of the target entry E4t with the write data WD and maintains the target entry E4t in the Dirty state (S5007).

In a case where the logical address LA of the target entry E4t is not X (S5006_No), the second cache control unit 401 evicts the data in the Dirty state of the target entry E4t and transmits the data to the nonvolatile memory 10 through the NAND controller 202. By this, the data in the Dirty state is written to the nonvolatile memory 10. Then, the second cache control unit 401 stores the write data WD in the target entry E4t in the Dirty state (S5008).

### 4.2 Effects According to Present Embodiment

According to the fourth embodiment, the effects similar to those of the first embodiment are obtained.

Also, the memory unit 42 of the second cache 24 does not have a copy of data stored in the memory unit 32 of the first cache 23. Therefore, according to the present embodiment, it is possible to improve the utilization efficiency of the second cache 24 while keeping the data in the first cache 23 and the second cache 24.

Of course, the third embodiment and the first modification and the second modification of the first embodiment can also be applied to the present embodiment.

### 5. Fifth Embodiment

A memory system according to a fifth embodiment will be described. The memory system 3 according to the fifth embodiment is different from that of the fourth embodiment in that the second embodiment is applied to the fourth embodiment. In the following description, points different from the fourth embodiment will be mainly described.

### 5.1 Operation of First Cache and Second Cache

### (Operation in Response to Prefetch Request PR)

An operation in response to the prefetch request PR will be described. The flowchart of the operation of the first cache 23 is the same as the flowchart of FIG. 17 illustrated in the fourth embodiment. The flowcharts of the operation of the second cache 24 are the same as the flowcharts of FIGS. 18 to 20 illustrated in the fourth embodiment.

### (Operation in Response to Read Request RR)

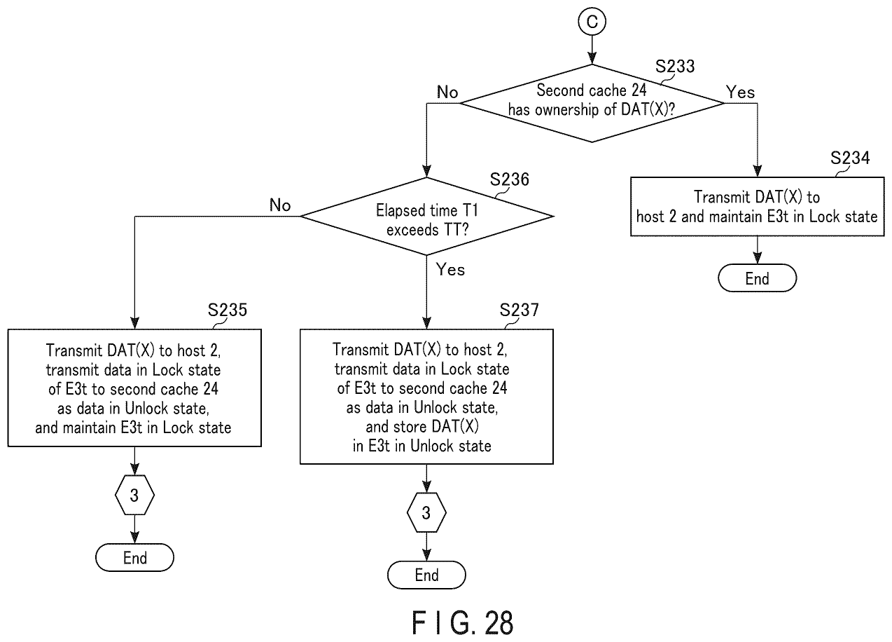

The operation in response to the read request RR will be described with reference to FIG. 28. FIG. 28 is a flowchart illustrating an example of the operation of the first cache 23.

In the flowchart of the operation of the first cache 23 illustrated in FIG. 28, steps S236 and S237 are added to the flowcharts of FIGS. 21 to 24 illustrated in the fourth embodiment. The flowchart of the operation of the second cache 24 is the same as the flowchart of FIG. 25 illustrated in the fourth embodiment.

As illustrated in FIG. 28, in a case where the second cache 24 does not have the ownership of the data DAT(X) (S233_No), the first cache control unit 301 performs the WDT determination process (S236).

In the WDT determination process, in a case where it is determined that the elapsed time T1 exceeds the constant time TT (S236_Yes), the first cache control unit 301 transmits data DAT(X) to the host 2, transmits the data in the Lock state of the target entry E3t to the second cache 24 as data in the Unlock state, and stores the data DAT(X) in the target entry E3t in the Unlock state (S237). After the execution of step S237, the first cache control unit 301 causes the second cache control unit 401 to execute the above-described process 3.

### (Operation in Response to Write Request WR)

An operation in response to the write request WR will be described. The flowchart of the operation of the first cache 23 is the same as the flowchart of FIG. 26 illustrated in the fourth embodiment. The flowchart of the operation of the second cache 24 is the same as the flowchart of FIG. 27 illustrated in the fourth embodiment.

### 5.2 Effects According to Present Embodiment

According to the fifth embodiment, the effects similar to those of the second embodiment and the fourth embodiment are obtained. Of course, the third embodiment and the first modification and the second modification of the first embodiment can also be applied to the present embodiment.

### 6. Sixth Embodiment

A memory system according to a sixth embodiment will be described. In the memory system 3 according to the sixth embodiment, the operations of the first cache 23 and the second cache 24 are partially different from those of the fourth embodiment. In the following description, points different from the fourth embodiment will be mainly described.

In the present embodiment, the memory unit 42 of the second cache 24 has a copy of the data stored in the memory unit 32 of the first cache 23. The operations of the first cache 23 and the second cache 24 are as follows.

### 6.1 Operation of First Cache and Second Cache

### (Operation in Response to Prefetch Request PR)

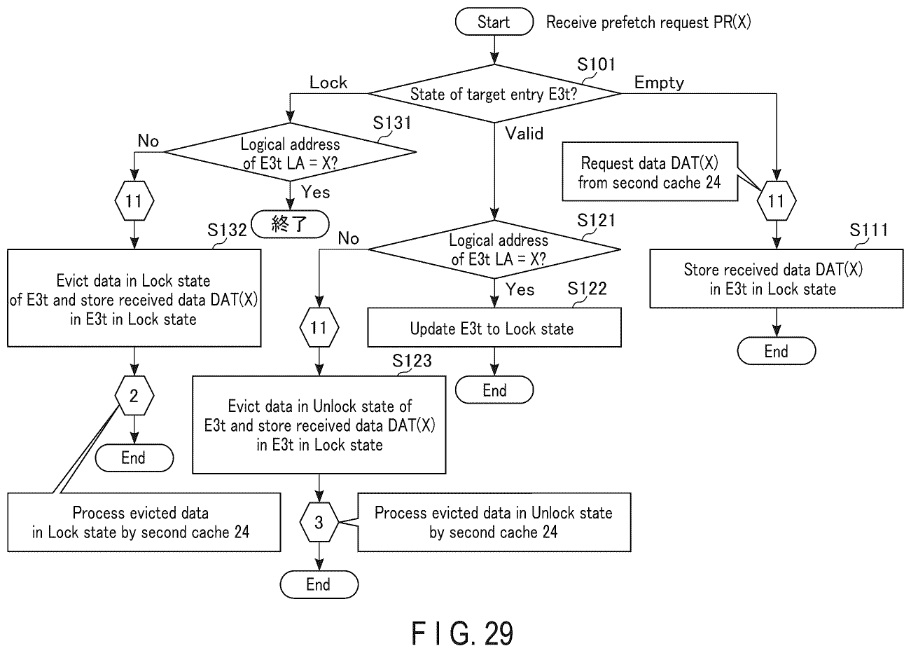

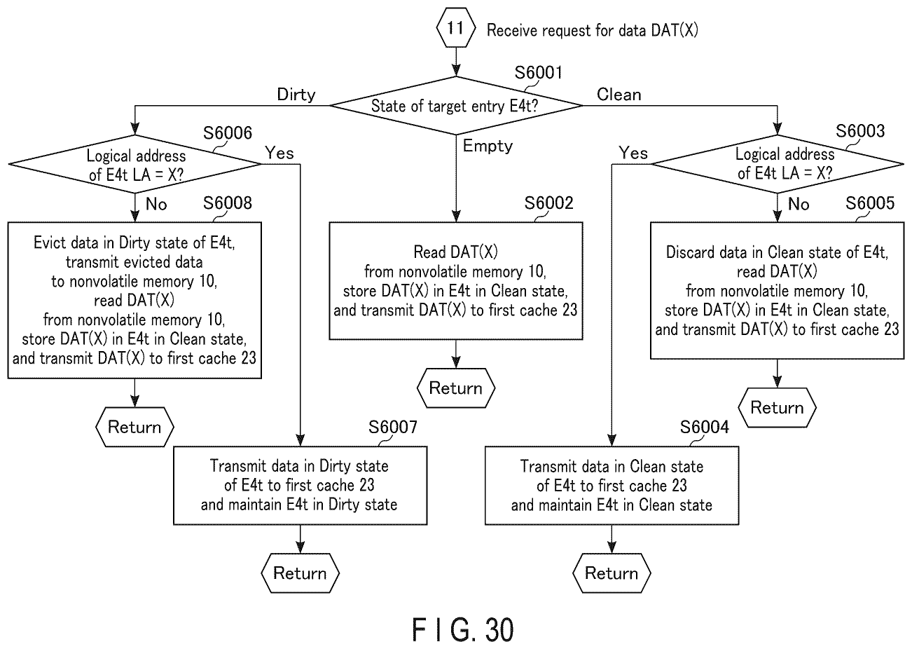

The operation in response to the prefetch request PR will be described with reference to FIGS. 29 and 30. FIG. 29 is a flowchart illustrating an example of the operation of the first cache 23. FIG. 30 is a flowchart illustrating an example of the operation of the second cache 24.

In the flowchart of the operation of the first cache 23 illustrated in FIG. 29, the process 1 of the flowchart of FIG. 17 illustrated in the fourth embodiment is replaced with a process 11.

### (Process 11)

The process 11 will be described. As illustrated in FIG. 30, upon receiving the request for data DAT(X) from the first cache 23, the second cache control unit 401 searches the memory unit 42 and checks a cache tag CT of the target entry E4t (S6001).

In a case where the target entry E4t is in the Empty state (S6001_Empty), the second cache control unit 401 reads the data DAT(X) from the nonvolatile memory 10 through the NAND controller 202, stores the read data DAT(X) in the target entry E4t in the Clean state, and transmits the data DAT(X) to the first cache 23 (S6002).

In a case where the target entry E4t is in the Clean state (S6001_Clean), the second cache control unit 401 determines whether or not the logical address LA of the target entry E4t is X (S6003).

In a case where the logical address LA of the target entry E4t is X (S6003_Yes), the second cache control unit 401 transmits the data in the Clean state of the target entry E4t to the first cache 23 and maintains the target entry E4t in the Clean state (S6004).

In a case where the logical address LA of the target entry E4t is not X (S6003_No), the second cache control unit 401 discards the data in the Clean state of the target entry E4t, reads the data DAT(X) from the nonvolatile memory 10 through the NAND controller 202, stores the read data DAT(X) in the target entry E4t in the Clean state, and transmits the data DAT(X) to the first cache 23 (S6005). Note that, instead of step S6005, the second cache control unit 401 may read the data DAT(X) from the nonvolatile memory 10, transmit the read data DAT(X) to the first cache 23, and maintain the target entry E4t in the Clean state. In this case, since two different pieces of data can be stored in the first cache 23 and the second cache 24, there is a high possibility that the cache efficiency is improved.

In a case where the target entry E4t is in the Dirty state (S6001_Dirty), the second cache control unit 401 determines whether or not the logical address LA of the target entry E4t is X (S6006).

In a case where the logical address LA of the target entry E4t is X (S6006_Yes), the second cache control unit 401 transmits the data in the Dirty state of the target entry E4t to the first cache 23 and maintains the target entry E4t in the Dirty state (S6007).

In a case where the logical address LA of the target entry E4t is not X (S6006_No), the second cache control unit 401 evicts the data in the Clean state of the target entry E4t and transmits the evicted data to the nonvolatile memory 10 through the NAND controller 202. Then, the second cache control unit 401 reads the data DAT(X) from the nonvolatile memory 10 through the NAND controller 202, stores the read data DAT(X) in the target entry E4t in the Clean state, and transmits the data DAT(X) to the first cache 23 (S6008). Note that, instead of step S6008, the second cache control unit 401 may read the data DAT(X) from the nonvolatile memory 10, transmit the read data DAT(X) to the first cache 23, and maintain the target entry E4t in the Dirty state. In this case, similarly to the case where the target entry E4t is in the Clean state, there is a high possibility that the cache efficiency is improved.

### (Operation in Response to Read Request RR)

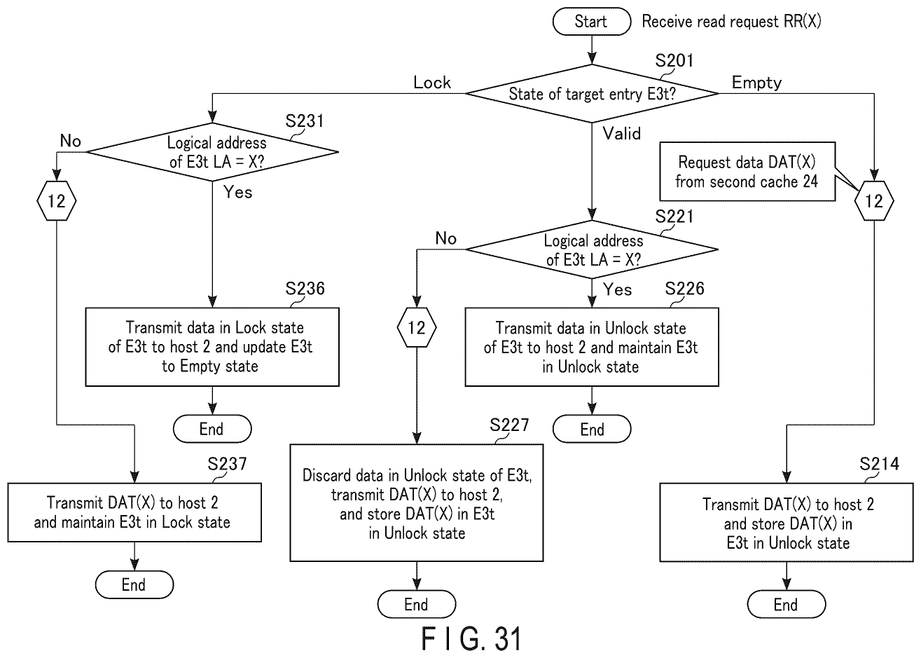

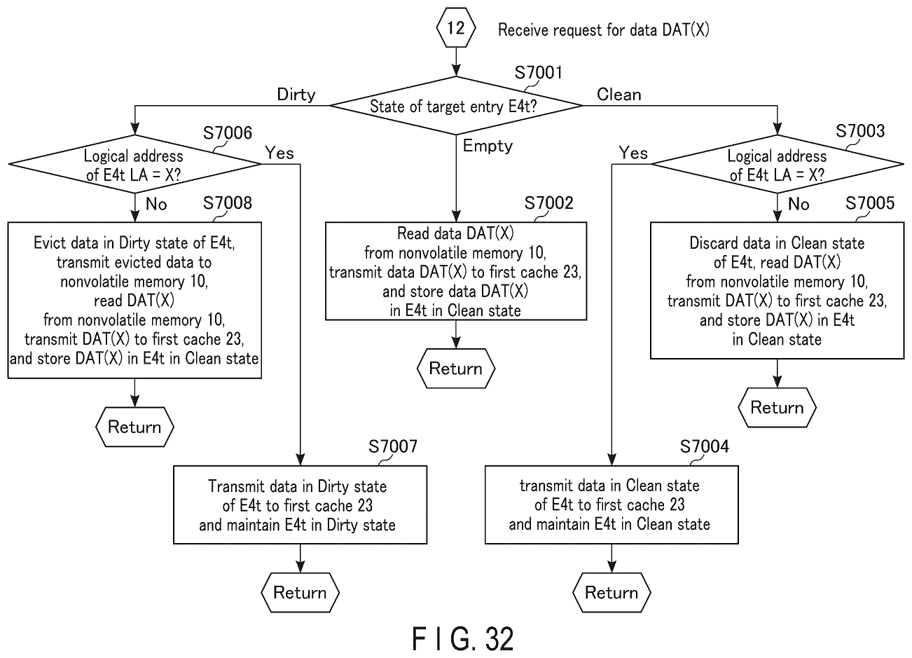

The operation in response to the read request RR will be described with reference to FIGS. 31 and 32. FIG. 31 is a flowchart illustrating an example of the operation of the first cache 23. FIG. 32 is a flowchart illustrating an example of the operation of the second cache 24.

In the flowchart of the operation of the first cache 23 illustrated in FIG. 31, the process 4 of the flowcharts of FIGS. 21 to 24 illustrated in the fourth embodiment is replaced with a process 12, steps S211 to S213 are replaced with step S214, steps S222 to S225 are replaced with steps S226 and S227, and steps S232 to S235 are replaced with steps S236 and S237.

As illustrated in FIG. 31, in a case where the target entry E3t is in the Empty state (S201_Empty), the first cache control unit 301 requests the data DAT(X) from the second cache 24. Specifically, the first cache control unit 301 causes the second cache control unit 401 to execute the process 12 (a process of reading the data DAT(X)), and receives the data DAT(X) from the second cache control unit 401. Details of the process 12 will be described later. After execution of the process 12, the first cache control unit 301 transmits the data DAT(X) to the host 2 and stores the data DAT(X) in the target entry E3t in the Unlock state (S214).

In a case where the target entry E3t is in the Valid state (S201_Valid) and the logical address LA of the target entry E3t is X (S221_Yes), the first cache control unit 301 transmits the data in the Unlock state of the target entry E3t to the host 2 and maintains the target entry E3t in the Unlock state (S226).

In a case where the target entry E3t is in the Valid state (S201_Valid) and the logical address LA of the target entry E3t is not X (S221_No), the first cache control unit 301 causes the second cache control unit 401 to execute the process 12 and receives the data DAT(X) from the second cache control unit 401. After execution of the process 12, the first cache control unit 301 discards the data in the Unlock state of the target entry E3t, transmits the data DAT(X) to the host 2, and stores the data DAT(X) in the target entry E3t in the Unlock state (S227).

In a case where the target entry E3t is in the Lock state (S201_Lock) and the logical address LA of the target entry E3t is X (S231_Yes), the first cache control unit 301 transmits the data in the Lock state of the target entry E3t to the host 2 and updates the target entry E3t to the Empty state (S236).

In a case where the target entry E3t is in the Lock state (S201_Lock) and the logical address LA of the target entry E3t is not X (S231_No), the first cache control unit 301 causes the second cache control unit 401 to execute the process 12 and receives the data DAT(X) from the second cache control unit 401. After execution of the process 12, the first cache control unit 301 transmits the data DAT(X) to the host 2 and maintains the target entry E3t in the Lock state (S237).

### (Process 12)

The process 12 will be described. As illustrated in FIG. 32, upon receiving the request for the data DAT(X) from the first cache 23, the second cache control unit 401 of the second cache 24 searches the memory unit 42 and checks the cache tag CT of the target entry E4t (S7001).

In a case where the target entry E4t is in the Empty state (S7001_Empty), the second cache control unit 401 reads the data DAT(X) from the nonvolatile memory 10 through the NAND controller 202, transmits the read data DAT(X) to the first cache 23, and stores the data DAT(X) in the target entry E4t in the Clean state (S7002).

In a case where the target entry E4t is in the Clean state (S7001_Clean), the second cache control unit 401 determines whether or not the logical address LA of the target entry E4t is X (S7003).

In a case where the logical address LA of the target entry E4t is X (S7003_Yes), the second cache control unit 401 transmits the data in the Clean state of the target entry E4t to the first cache 23 and maintains the target entry E4t in the Clean state (S7004).

In a case where the logical address LA of the target entry E4t is not X (S7003_No), the second cache control unit 401 discards the data in the Clean state of the target entry E4t, reads the data DAT(X) from the nonvolatile memory 10 through the NAND controller 202, transmits the read data DAT(X) to the first cache 23, and stores the data DAT(X) in the target entry E4t in the Clean state (S7005). Note that, instead of step S7005, the second cache control unit 401 may read the data DAT(X) from the nonvolatile memory 10, transmit the read data DAT(X) to the first cache 23, and maintain the target entry E4t in the Clean state.

In a case where the target entry E4t is in the Dirty state (S7001 Dirty), the second cache control unit 401 determines whether or not the logical address LA of the target entry E4t is X (S7006).

In a case where the logical address LA of the target entry E4t is X (S7006_Yes), the second cache control unit 401 transmits the data in the Dirty state of the target entry E4t to the first cache 23 and maintains the target entry E4t in the Dirty state.

In a case where the logical address LA of the target entry E4t is not X (S7006_No), the second cache control unit 401 evicts the data in the Dirty state of the target entry E4t and transmits the data to the nonvolatile memory 10 through the NAND controller 202. By this, the data in the Dirty state is written to the nonvolatile memory 10. Then, the second cache control unit 401 reads the data DAT(X) from the nonvolatile memory 10 through the NAND controller 202, transmits the read data DAT(X) to the first cache 23, and stores the data DAT(X) in the target entry E4t in the Clean state (S7008). Note that, instead of step S7008, the second cache control unit 401 may read the data DAT(X) from the nonvolatile memory 10, transmit the read data DAT(X) to the first cache 23, and maintain the target entry E4t in the Dirty state.

### (Operation in Response to Write Request WR)

An operation in response to the write request WR will be described. The flowchart of the operation of the first cache 23 is the same as the flowchart of FIG. 26 illustrated in the fourth embodiment. The flowchart of the operation of the second cache 24 is the same as the flowchart of FIG. 27 illustrated in the fourth embodiment.

### 6.2 Effects According to Present Embodiment

According to the sixth embodiment, the effects similar to those of the first embodiment are obtained.

The memory unit 42 of the second cache 24 has a copy of the data stored in the memory unit 32 of the first cache 23. Therefore, according to the present embodiment, since data can be discarded unconditionally in the first cache 23, the operations of the first cache 23 and the second cache 24 can be simplified.

Further, when a set of the prefetch request PR and the read request RR are repeated for the same data, in a case where the prefetch data PD is stored in the second cache 24, the prefetch data PD can be transmitted from the second cache 24 to the first cache 23. Therefore, according to the present embodiment, the number of accesses to the nonvolatile memory 10 can be reduced.

Of course, the second embodiment, the third embodiment, and the first modification and the second modification of the first embodiment can also be applied to the present embodiment.

### 7. Modifications and the Like

As described above, the memory system (3) according to the embodiment includes a nonvolatile memory (10) and a memory controller (20). The memory controller (20) includes a first cache (23) connectable to a host (2), a second cache (24) connected to the first cache, and a first controller (202) that controls a nonvolatile memory. The first cache (23) includes a first memory unit (32) that has an SRAM as a memory element and stores prefetch data and read data from the nonvolatile memory, and a first control unit (301) that controls the first memory unit. The second cache (24) includes a second memory unit (42) that has a DRAM as a memory element and stores the read data and write data from the host, and a second control unit (401) that controls the second memory unit. Each of a plurality of logical addresses designated by the host (2) is mapped to the first memory unit (32) by an index. The first memory unit (32) includes a plurality of entries each having tag information of the index and having a cache tag (CT) including a first field (F2) and a cache line (CL). In a case where the first control unit (301) receives a first prefetch request (PR) for first data of a first logical address, the first control unit stores the prefetched first data in the cache line of a first entry included in the first memory unit, and stores a first value indicating that the first data is the prefetch data in the first field of the first entry. The first control unit (301) maintains the first entry until receiving a read request (RR) or a write request (WR) for the first logical address from the host (2).

Note that the embodiment is not limited to the above-described embodiment, and various modifications are possible.

In addition, in the flowchart described in the above embodiment, the order of the processes can be changed as much as possible.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory; and
a memory controller that includes:
a first cache including a first memory unit and a first control unit controlling the first memory unit, the first memory unit having an SRAM as a memory element and storing prefetch data and read data from the nonvolatile memory, the first cache being connectable to a host;
a second cache including a second memory unit and a second control unit controlling the second memory unit, the second memory unit having a DRAM as a memory element and storing the read data and write data from the host, the second cache being connected to the first cache; and
a first controller being configured to control the nonvolatile memory,
wherein
each of a plurality of logical addresses designated by the host is mapped to the first memory unit by an index,
the first memory unit includes a plurality of entries each having tag information of the index and having a cache tag including a first field and a cache line,
in a case where the first control unit receives a first prefetch request for first data of a first logical address, the first control unit is configured to store the prefetched first data in the cache line of a first entry included in the first memory unit, and store a first value indicating that the first data is the prefetch data in the first field of the first entry, and
the first control unit is configured to maintain the first entry until receiving a read request or a write request for the first logical address from the host.

2. The memory system according to claim 1,
wherein
when the first control unit receives the first prefetch request, in a case where data is not stored in the cache line of the first entry, the first control unit is configured to store the first data read from the second cache or the nonvolatile memory in the cache line of the first entry, and store the first value in the first field of the first entry.

3. The memory system according to claim 1,
wherein
when the first control unit receives the first prefetch request, in a case where the first data is stored in the cache line of the first entry and the first value is not stored in the first field of the first entry, the first control unit is configured to update the first field of the first entry to the first value.

4. The memory system according to claim 1,
wherein
when the first control unit receives the first prefetch request, in a case where the first data is stored in the cache line of the first entry and the first value is stored in the first field of the first entry, the first control unit is configured to maintain the first entry.

5. The memory system according to claim 1,
wherein
when the first control unit receives the first prefetch request, in a case where second data of a second logical address different from the first logical address is stored in the cache line of the first entry, the first control unit is configured to evict the second data from the first entry, store the first data read from the second cache or the nonvolatile memory in the cache line of the first entry, and store the first value in the first field of the first entry.

6. The memory system according to claim 1,
wherein
when the first control unit receives a read request for the first data of the first logical address from the host, in a case where data is not stored in the cache line of the first entry, the first control unit is configured to transmit the first data read from the second cache or the nonvolatile memory to the host, store the first data in the cache line of the first entry, and store a second value indicating that the first data is not the prefetch data in the first field of the first entry.

7. The memory system according to claim 1,
wherein
when the first control unit receives a read request for the first data of the first logical address from the host, in a case where the first data is stored in the cache line of the first entry and the first value is not stored in the first field of the first entry, the first control unit is configured to transmit the first data of the first entry to the host and maintain the first entry.

8. The memory system according to claim 1,
wherein
when the first control unit receives a read request for the first data of the first logical address from the host, in a case where the first data is stored in the cache line of the first entry and the first value is stored in the first field of the first entry, the first control unit is configured to transmit the first data of the first entry to the host and clear the cache line and the first field of the first entry.

9. The memory system according to claim 1,
wherein
when the first control unit receives a read request for the first data of the first logical address from the host, in a case where second data of a second logical address different from the first logical address is stored in the cache line of the first entry and the first value is not stored in the first field of the first entry, the first control unit is configured to evict the second data from the first entry, transmit the first data read from the second cache or the nonvolatile memory to the host, store the first data in the cache line of the first entry, and store a second value indicating that the first data is not the prefetch data in the first field of the first entry.

10. The memory system according to claim 1,
wherein
when the first control unit receives a read request for the first data of the first logical address from the host, in a case where second data of a second logical address different from the first logical address is stored in the cache line of the first entry and the first value is stored in the first field of the first entry, the first control unit is configured to transmit the first data read from the second cache or the nonvolatile memory to the host and maintain the first entry.

11. The memory system according to claim 1,
wherein
when the first control unit receives a write request for the first logical address from the host, in a case where data is not stored in the cache line of the first entry, the first control unit is configured to maintain the first entry.

12. The memory system according to claim 1,
wherein
when the first control unit receives a write request for the first logical address from the host, in a case where the first data is stored in the cache line of the first entry, the first control unit is configured to clear the cache line and the first field of the first entry.

13. The memory system according to claim 1,
wherein
when the first control unit receives a write request for the first logical address from the host, in a case where second data of a second logical address different from the first logical address is stored in the cache line of the first entry, the first control unit is configured to maintain the first entry.

14. The memory system according to claim 1,
wherein
the memory controller further includes a second controller being configured to control a prefetch process, and
the first prefetch request is transmitted to the first control unit by the second controller based on designation of the prefetch process by a user.

15. The memory system according to claim 1,
wherein
the memory controller further includes a second controller being configured control a prefetch process, and
the first prefetch request is transmitted to the first control unit by the second controller.

16. The memory system according to claim 1,
wherein
the first prefetch request is transmitted to the first control unit by the host.

17. The memory system according to claim 1,
wherein
the first cache further includes a measurement unit being configured to measure an elapsed time from a time at which the first value is stored in the first field of the first entry to a current time, and
in a case where the result measured by the measurement unit exceeds a constant time, the first control unit is configured to update the first field of the first entry to a second value indicating that the first data is not the prefetch data.

18. The memory system according to claim 1,
wherein
the memory controller further includes
a table for translating the logical address to a physical address of the nonvolatile memory, and
a line size of the cache line of the first memory unit is a same as a management size of the table.

19. The memory system according to claim 1,
wherein
the second memory unit does not have a copy of data stored in the first memory unit.

20. The memory system according to claim 1,
wherein
the second memory unit has a copy of data stored in the first memory unit.
